(19) United States
(12) Patent Application Publication
(10) Pub. No.: US 2008/0064841 A1
(43) Pub. Date: Mar. 13, 2008

(54) Polymerization Using Ligand-Initiators and Ligand-Terminators

(76) Inventors: Urs Hafeli, Vancouver (CA); Katayoun Saatchi, North Vancouver (CA)

Correspondence Address: BIO TECHNOLOGY LAW GROUP;C/O PORTFOLIOIP, P.O. BOX 52050, MINNEAPOLIS, MN, 55402, US

(21) Appl. No.: 11/774,549

(22) Filed: Jul. 6, 2007

Related U.S. Application Data
(60) Provisional application No. 60/818,967, filed on Jul. 7, 2006.

(51) Int. Cl. C08G 63/08

(52) U.S. Cl. 528/9; 528/354

(57) ABSTRACT

Polymers comprising a chelating agent, and polymerized using the chelating agent as an initiator or terminator are described.

### CROSS-REFERENCE TO RELATED APPLICATIONS

This application claims the benefit of and priority to U.S. provisional patent application Ser. No. 60/818,967, filed Jul. 7, 2006, which is incorporated herein by reference.

### FIELD OF INVENTION

The present invention relates to the field of biocompatible polymers having metal-binding ligands.

### BACKGROUND OF THE INVENTION

Biocompatible polymers have a myriad applications in biology and medicine, particularly in therapeutics such as drug delivery, implants and surgical devices. Other applications may involve imaging of soft tissues, or monitoring of metabolites in response to a drug, for example. Metal atoms, radioactive or not, are well-established as tracing agents. Technetium 99m is one example of a frequently used radionuclide for diagnostic imaging. Rhenium 186 and rhenium 188 are examples of frequently mentioned radionuclides for potential therapeutic applications. Numerous examples of each are described in the art, as are examples of other metals, radioactive or not, that have been employed in both diagnostic and therapeutic applications.

Control of the distribution of the metal atom is important—restriction of the radionuclide to a therapeutic site, such as an implant seed in brachytherapy, or within a tissue or system (for example, the gastrointestinal tract) is important both for safety and for accuracy of treatment. To facilitate this, the metal atoms may be coupled to a carrier, such as a polymer bead or pellet, or to a small molecule.

Any polymer used to produce the bead, seed or other implant is desirably non-toxic and compatible with the recipient, as well as compatible with the metal atom used as the metallopharmaceutical or radiopharmaceutical. Ligands are frequently employed to bind the metal atom to the implant or carrier, and to do so must themselves be fixed in some way to the implant or carrier.

“Tailoring” ligands to bind particular metal atoms well is an active area of research.

Storr et al 2006. Chem. Soc. Rev 35:534-544 reviews advances in ligand design and development, and their use in therapeutic small molecule compounds and antibodies.

Banerjee et al. 2005. Dalton Transactions 24: 3886-3897 describes design and methods for synthesis of ligands for technetium and rhenium, as well as labelling of glutathione and serum albumins.

US patent application 2006/0093552 describes peptides comprising ligand moieties that may bind technetium and rhenium.

Yu et al 2005. Nuclear Medicine Communications 26:453-458 describes methods for labelling poly-histidine derivatized PLA microspheres with rhenium. This publication describes a multi-step method of first making the microspheres, and labelling with a Re-tricarbonyl complex, either directly on the free —COOH groups of the microspheres, or first further derivatizing the microspheres to provide free —NH₂ groups, followed by labelling with the Re-tricarbonyl complex.

Corbin et al 2001. Biomacromolecules 2:223-232 describes synthesis of PLA and other related polymers having bipyridine-ligands at one end, and subsequently complexing these polymers with iron or ruthenium atoms to provide dendrimer-like structures with the iron or ruthenium atom at the core.

### SUMMARY OF THE INVENTION

The present invention relates to a polymer comprising a chelating agent at an end of a polymer chain, and methods of making such polymers.

In one aspect, the invention provides a polymer comprising a chelating agent at an end of a polymer chain (a “ligand-polymer”), where the chelating agent comprises a dentate structure e.g., a bidentate, tridentate, tetradentate, pentadentate, hexadentate, heptadentate, or octadentate structure.

In alternative embodiments, there is provided a ligand-polymer according to any one of formula 1, 2, 3, 4, 5, 6 or 7 (Table 1). The ligand-polymer may further comprise a metal atom. The metal atom may be selected from Re, Tc, Cu, Ga, In, Y, La, Pr, Nd, Sm, Eu, Yb, Tb, Ho, Dy, Er, Tm, Lu, Ti, V, Cr, Mo, W, Mn, Tc, Fe, Ru, Co, Ni, Pt, Cu, Ag, Au, Zn, Cd, Hg, Tl, Sb, Al, Rh, Zr, Pd or Bi. The metal may be radioactive. The ligand-polymer may be polylactic acid, polyglycolic acid, polycaprolactone, or copolymers thereof.

In some embodiments, a ligand polymer can have the following structure

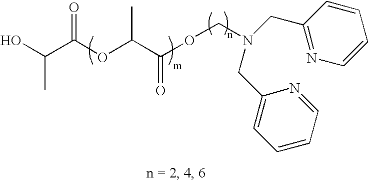

where “m” and “n” can be any number. In some embodiments, “n” can be any number from 1 to 6, inclusive. Exemplary ligand-polymers include those shown in Table 1.

TABLE 1
Ligand-polymers

| | | Alernate naming |
|---|---|---|
| Formula | Structure | reference |
| 1 | 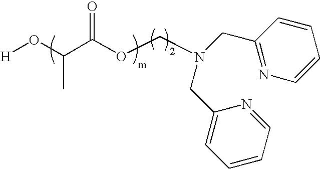 | PLA—OC₂N₃ |
| 2 | 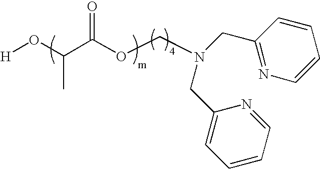 | PLA—OC₄N₃ |
| 3 | 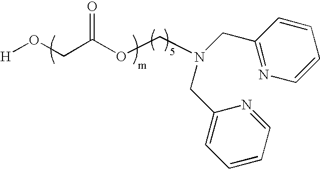 | PLA—OC₅N₃ |
| 4 | 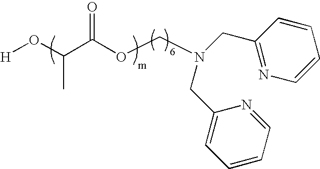 | PLA—OC₆N₃ |
| 5 | 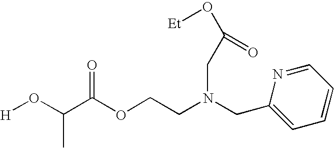 | PLA—OC₂N₂O |
| 6 | 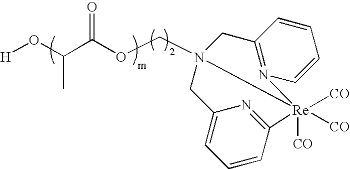 | PLA—OC₂N₃Re(CO)₃ |
| 7 | 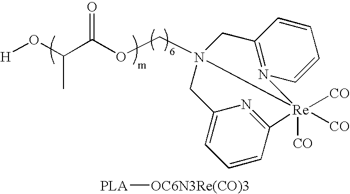 | PLA—OC₆N₃Re(CO)₃ |

In some embodiments, ligand-polymers having the following structure may be specifically excluded:

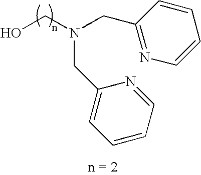

According to another aspect of the invention, there is provided a method of making a ligand-polymer according to any one of formula 1, 2, 3, 4, 5, 6 or 7, the method comprising heating a monomer with a ligand-initiator or ligand-terminator in a solvent or without solvent in the presence of a catalyst. The ligand-initiator or ligand-terminator may be selected from structure 1, 2, 3, 4, 5, 6, 7, 8, 9, 10, 11 or 12 (Table 2, where “n” can be any number from 1 to 6, inclusive). In alternative embodiments, the ligand-initiator or ligand-terminator may include multidentate structures, e.g., bidentate, tridentate, tetradentate, pentadentate, hexadentate, heptadentate, or octadentate structures.

TABLE 2
Ligand Initiators or Terminators

| Structure | Structure No. |
|---|---|
| 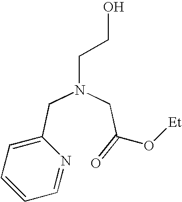 | 1 |
| 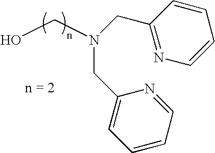 | 2 |
| 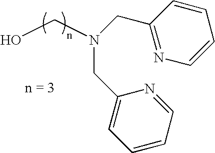 | 3 |
| 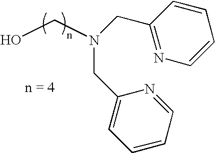 | 4 |
| 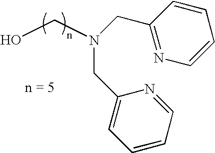 | 5 |
| 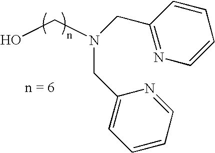 | 6 |
| 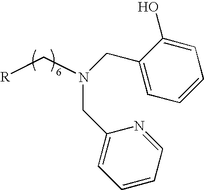 | 7 |
| 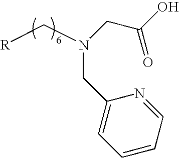 | 8 |
| 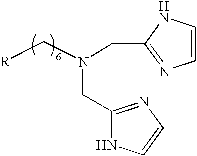 | 9 |
| 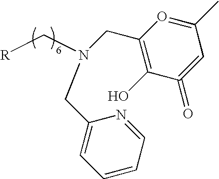 | 10 |
| 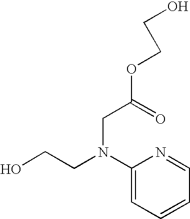 | 11 |
| 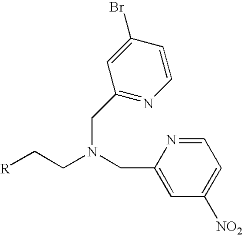 | 12 |
| 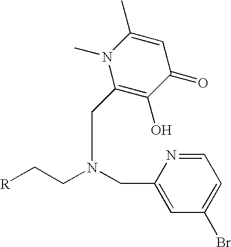 | 13 |
| 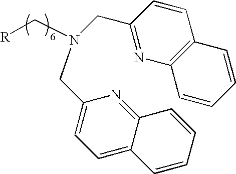 | 14 |

According to another aspect of the invention, there is provided a method of making a ligand-polymer comprising at least one metal atom, the method comprising combining a ligand-polymer according to any of formula 1, 2, 3, 4, 5, 6 or 7 in a solvent with a metal salt, and removing the solvent.

According to another aspect of the invention, there is provided a use of a ligand-polymer in the preparation of an implant.

According to another aspect of the invention, there is provided a use of a ligand-polymer comprising a metal atom in the preparation of an implant.

According to another aspect of the invention, there is provided a use of a ligand-polymer comprising at least one metal atom in the preparation of a metallopharmaceutical.

According to another aspect of the invention, there is provided a use of a ligand-polymer comprising at least one metal atom in the preparation of a radiopharmaceutical.

The ligand-polymer may be any of formula 1, 2, 3, 4, 5, 6 or 7.

According to another aspect of the invention, there is provided a composition comprising a ligand polymer according to any one of formula 1, 2, 3, 4 or 5, and at least one metal atom.

In accordance with another aspect of the invention, there are provided methods for producing a polymer comprising a chelating agent at an end of the polymer chain. The method may comprise a ring-opening polymerization, condensation polymerization, or step growth polymerization. Depending on the polymerization mechanism, the chelating agent may function as an initiator or a terminator.

In accordance with another aspect of the invention, the chelating agents are at least bidentate, tridentate, tetradentate, pentadentate, hexadentate, heptadentate or octadentate. In some embodiments, the chelating agent bipyridine is specifically excluded.

The polymer may be biodegradable, or biocompatible, or both or neither. Polymers according to various aspects of the invention may be used in the production of radiopharmaceuticals, or in the production of implantable materials that provide a source of radioactivity in a patient. The radiopharmaceuticals may be used in therapeutic applications, and may be transient in the subject, or may be implanted on a semi-permanent or permanent basis. Radiolabeled polymers in any shape and form may also be used as radiation sources and/or calibration sources for technical or nuclear medicine applications.

Alternatively, the polymer according to various aspects of the invention may be provided to a patient in a manner that enables the chelating agent to sequester metal atoms present in the patient.

In some embodiments, the invention provides a method of treating a patient in need thereof, comprising administering to said patient the ligand-polymer or composition according to the invention.

In some embodiments, the structures described herein may be used as precursors for further processes, e.g., for further iodination.

Polymers according to various aspects of the invention may comprise without limitation lactones, such as substituted lactones, caprolactone, substituted caprolactones; lactams or substituted lactams; anhydrides, acids, carbonates, isocyanates, alcohols or amines and the like.

In some embodiments, the chelating agent is not 4,4′-bis(hydroxymethyl)-2,2′-bipyridine.

This summary of the invention does not necessarily describe all features of the invention. Other aspects and features of the present invention will become apparent to those of ordinary skill in the art upon review of the following description of specific embodiments of the invention.

### BRIEF DESCRIPTION OF THE DRAWINGS

These and other features of the invention will become more apparent from the following description in which reference is made to the appended drawings wherein:

FIG. 1 shows a scheme illustrating a ring-opening polymerization of L-lactide using a generic bis(picolylamine) functionalized alcohols as initiators and metal coordination of the resulting polymer (R=2-ethylhexanoate, n=2, 4, 6), in accordance with an embodiment of the present invention.

FIG. 2 shows an ¹H NMR spectra of the starting initiator in comparison to the synthesized polymer for N,N-bis(2-methylpyridine)-2-aminoethanol and the resulting polymer. The polymer has formed with >98% lactide conversion based on NMR integration, with the bis(picolylamine)ethanol as the cap. 2-N(2-CH₂Py)₂ethanol (upper spectra tracing) and PLA-OC₂N₃ (formula 1) (lower spectra tracing). The two lower boxes are blowups of the regions shown with the arrow in the spectrum, in accordance with an embodiment of the present invention.

FIG. 3 shows a MALDI-TOF spectrum of the polymer with a maximum mass of 1833 for PLA-OC₂N₃ (formula 1) indicating a 22 repeat unit polymer chain. The weight distribution is between 1200-3000 for the polymer chains, in accordance with an embodiment of the present invention.

FIG. 4 shows an ¹H NMR spectra of PLA-OC₂N₃ (formula 1; upper tracing) and PLA-OC₂N₃Re(CO)₃ (formula 6 lower tracing), in accordance with an embodiment of the present invention.

FIG. 5 shows IR spectra of the Re(CO)₃ precursor (top tracing), PLA-OC₂N₃ (formula 1) (middle tracing) and PLA-OC₂N₃Re(CO)₃ (formula 6) (bottom tracing), in accordance with an embodiment of the present invention.

FIG. 6 shows a MALDI-TOF spectrum of the metal coordinated polymer, illustrating a maximum mass of about 1811 for PLA-OC₂N₃Re(CO)₃ (formula 6) for an 18 repeat unit polymer chain, in accordance with an embodiment of the present invention.

FIGS. 7A-C show various spectra of PLA-OC₄N₃ (formula 2): a) ¹H NMR; b) MALDI-TOF mass spectrum; c) IR spectrum, in accordance with an embodiment of the present invention.

FIGS. 8A-C show various spectra of PLA-OC₆N₃ (formula 4): a) ¹H NMR; b) MALDI-TOF mass spectrum; c) IR spectrum, in accordance with an embodiment of the present invention.

FIGS. 9A-C show various spectra of PLA-OC₂N₂O (formula 5): a) ¹H NMR; b) MALDI-TOF mass spectrum, c) ¹H NMR spectrum of formula 6 in comparison with the unbound polymer-ligand, in accordance with an embodiment of the present invention.

FIGS. 10A-C show various spectra of PLA-OC₆N₃Re(CO)₃ (formula 7): a) ¹H NMR; b) MALDI-TOF mass spectrum; c) IR spectrum, in accordance with an embodiment of the present invention.

FIG. 11 shows a scanning electron microscopy picture of the microspheres made with PLA-OC₂N₃Re(CO)₃ using a solvent evaporation method.

FIG. 12 shows a film made from 90% PLGA 50:50 and 10% PLA-OC₆N₃, one embodiment of the present invention. The polymer was placed in a steel block, heated for 20 min at 110° C. and pressed into a film at 41 kPa for 10 s. Disks of 4 mm diameter were punched out of this film for radiolabelling.

FIG. 13 shows ¹H-¹³C HMQC NMR (CDCl₃) spectrum of formula 7.

FIG. 14 shows ¹H and ¹³C NMR (CDCl₃) spectra of 6a.

FIG. 15 shows IR spectra of [Re(CO)₃]⁺ core, commercial L-PLA, 6, 6a and 7.

FIG. 16 shows the MALDI-TOF mass spectrum of 6. The inset shows a single signal for one oligomer chain (n=18) and its simulation signal.

FIG. 17 shows ¹H NMR (CDCl₃, 300 MHz) spectra of compounds 1, 2 and 4.

### DETAILED DESCRIPTION

In some aspects, the invention provides polymers that efficiently incorporate metal-specific chelators. If the chelator is used to initiate the polymerization reaction, rather than being ‘tagged’ onto an end of a polymer chain after polymerization, incorporation of the chelating ligand occurs at an end of every polymer chain, rather than a subset of those available post-polymerization. By incorporating more chelating ligands, the metal atom labelling of the polymer is more efficient. Further, use of a ‘one-pot’ synthesis reduces the number of steps and thus may increase the yield of final product. The labelled polymers according to some embodiments of the invention may be useful as carriers of radioactive metal atoms for delivery to specific tissues for imaging and diagnostic applications, such as positron emission tomography, magnetic resonance imaging or single photon emission tomography. The polymers may be produced or cast into a variety of configurations from colloidal suspensions of nano- or microparticles, films, wafers, micelles, pellets, threads or implants or the like. The cast polymers carrying radioactive metal atoms may be implanted at or near a tumor site, providing a more direct dose of radiation where needed, and reducing full-body exposure of the subject.

In some embodiments, functionalized alcohols in which the functionality provides a suitable environment for metal coordination were used as initiators in the ring opening polymerization of L-lactide. The resulting polyester chains are thus equipped with a tailored end group appropriate for metal chelation, i.e., polymers with a “grip,” resulting in a simple synthesis where a one-step reaction can produce modified polymer chains suitable for metal binding. The ligand initiators or ligand terminatorscan be tailored to bind the metals of choice, for example, ligands suitable for binding Re and Tc metal ions were used as the initiator, as described herein.

In the Examples described herein, the polymer syntheses proceeded from L-lactide using the commercially available and FDA approved stannous octoate as the catalyst. All ligand-initiators were synthesized similar to published procedures with minor modifications. In brief, addition of 2-picolyl chloride in a 2:1 ratio to the desired aminoalcohol in the presence of a strong base (or reacting 2-pyridinecarboxaldehyde with the desired aminoalcohol and further reduction with a suitable reducing agent (reductive alkylation)) resulted in the formation of the 2-picolylamine functionalized alcohol ligand initiators. The final products were purified by column chromatography using basic alumina and 5% methanol in chloroform and characterized by ¹H NMR and EA. These compounds were then used as the ligand-initiator in the polymerization of L-lactide. Polymerization was conducted in toluene under absolute conditions at 125° C. for a period of 3 h with a monomer to ligand-initiator ratio of 20:1 which resulted in monomer conversion of about 90% in different experiments. The resulting ligand-polymers were isolated in good yields and characterized by various techniques. Elemental analysis was used as a qualitative probe to prove the presence of nitrogen in the ligand-polymer products, a confirmation to the presence of the bis(picolylamine) moiety. ¹H NMR of all ligand-polymers shows the PLA backbone with an excellent turnover of the starting monomer. The data agree with reported literature values for PLA. Also, the corresponding ligand-initiator signals were detected along the base line of the spectrum of the polymer chain. Discrete, nicely resolved peaks were observed for the 2-methylpyridine moieties, the methylene groups on the alcohol backbone and the terminal methine and methyl groups in the polymer chain. The integration ratios for the picolylamine ligands and the terminal methine in the polymer chain are about 1:1 implying that there is one aminoalcohol per chain of polymer and confirming that the aminoalcohol is the initiator for polymerization. The Re complexes were synthesized from [Et₄N]₂[ReBr₃(CO)₃] and the ligand-polymers by refluxing in CH₂Cl₂ or CH₃CN at 50° C. The crude product was washed with MeOH to remove the Et₄NBr side product and the coordinated polymers isolated as light beige solids.

In the description that follows, a number of terms are used extensively, and the following definitions are provided to facilitate understanding of various aspects of the invention. Use of examples in the specification, including examples of terms, is for illustrative purposes only and is not intended to limit the scope and meaning of the embodiments of the invention herein.

A chemical bond generally refers to the physical manifestation of chemical substances held together by the sharing and/or exchanging of electrons. Chemical bonds may be strong or weak. Examples of strong chemical bonds are those found in molecules or metals, and are organized in an ordered structure, for example a crystal. Examples of weak chemical bonds are those resulting from the polarity of the interacting molecules, or the induced polarity of the interacting molecules.

A covalent bond generally refers to a chemical bond formed by each of two atoms participating in the bond formation by contributing one electron to the bond. The pair of electrons is shared equally by each atom and does not ‘belong’ exclusively to one atom alone.

A coordinate covalent bond generally refers to a bond where a pair of electrons donated by one of the two atoms participating in the bond, the other atom accommodating the pair of electrons. For example, the donor atom of the pair of electrons may be N, O, P or S, Si, and the accommodating atom may be any metal, for example Re, Tc, Cu, Ga, In, Y or lanthanide series metals, for example, La, Pr, Nd, Sm, Eu, Yb, Tb, Ho, Dy, Er, Tm, Lu, or other metal atoms such as Ti, V, Cr, Mo, W, Mn, Tc, Fe, Ru, Co, Ni, Pt, Cu, Ag, Au, Zn, Cd, Hg, Tl, Sb, Bi and the like.

Metal complexes may be produced by coordinate covalent bonds formed by electrons donated by a chemical species having a lone pair of electrons. Such complexes may be cationic, anionic or neutral.

Polymers

A “polymer” generally refers to a molecule comprising repeating monomeric structural units (monomers) connected by covalent bonds. The monomers may be identical, similar, or complementary within a polymer molecule. The monomers are linked in a chemical reaction referred to as polymerization. A polymer incorporating more than one species of monomer may be referred to as a copolymer, and the chemical reaction that links them as copolymerization. Copolymers may be described as random, alternating or block copolymers, depending on the monomers and reaction conditions used to generate them. Polymers and copolymers may be generally described as linear or branched, crosslinked, thermoplastic, thermoset or elastomeric, or combinations of these.

The choice of polymer may be made depending on the desired application. In some embodiments, the polymer may be biocompatible.

The term “biodegradable” generally refers to a composition that is capable of being decomposed in or by a biological system. For example, a biodegradable polymer may be broken down by enzymatic activity within a tissue or implant site into monomeric, or small multimeric units.

The term “biocompatible” generally refers to the ability of a material to perform with an appropriate subject response in a specific application. For example, the biocompatibility of an implantable material refers to the ability of the material to perform its intended function, with a desired degree of incorporation in the subject, without eliciting an undesirable level of systemic or localized effect in the subject. A biocompatible material, such as a polymer, may be capable of being degraded or absorbed by the subject, or it may not. A biocompatible material may be temporarily or permanently placed on or in a subject.

In various embodiments of the invention, the polymers may be copolymers such as poly(lactide-co-glycolide) (PLGA). PLGA is a synthetic, resorbable polymer with known applications in guided tissue regeneration and drug delivery. Without the inclusion of elasticizing agents, PLGA films are relatively stiff and inelastic, with a long degradation profile. Under normal physiological conditions, PLGA films degrade over a 1 to 6 month period (Andersen and Shive, 1997. Adv. Drug. Del. Rev. 28:5-24; Webber et al., 1997. J Biomed Mater Res. 41: 18-29; Lichun et al. 1999. J. Biomed Mater. Res 46:236-2444).

Ligands

The term “ligand” generally refers to an atom, ion or molecule, or a functional group comprising an atom, ion or molecule, or a functional group that donates (through a covalent bond) or shares (through a coordinate covalent bond) at least one of its electrons with one or more atoms or ions. For example, a ligand that donates at least one pair of electrons may be described as a Lewis base, while a ligand that accepts at least one electron may be described as a Lewis acid. Ligands or ligand functional groups may include, but are not limited to, NH₃, —CN, —SH, —COO, —NH₂, —CO, N₂O, NO₂, N₃, N₂O₂, N₃O, NO₃, N₂S₂, N₃S, NS₃, N₄O₂, N₂O₄, N₃O₃, N₃O₂, N₃O₅, N₄O₄, N₄O₄, N₅O₃, N₆O₂, N₄O₄ or any combination of donor atoms based on the ligand design such as substituted diamines or triamines in combination with other molecules having N, O, P or S donors. In some embodiments, ligands or ligand functional groups may include, but are not limited to, phosphines i.e., ligands of the general formula PR₃ where R=alkyl, aryl, H, halide, such as trimethylphosphine, triphenylphosphine, methyldiphenylphosphine, trifluorophosphine, tricyclohexylphosphine, triphenylphosphite, trimethylphosphite, BINAP (2,2′-bis(diphenylphosphino)-1,1′-binaphthyl), etc. In some embodiments, ligands or ligand functional groups may include, but are not limited to, diethylenetriaminepentaacetic acid (DTPA) and gadolinium tetraazacyclododecanetetraacetic acid (DOTA). Other examples of ligands or ligand functional groups will be known to those of skill in the art. Ligand groups may alternately be referred to as ‘metal-binding centres’.

In some embodiments of the invention, a ligand may be used as an initiator in a ring-opening polymerization. Suitable ligands include those with at least one —OH, —SH or —NH₂ functional group. A ligand may have more than one of such functional groups, and may, for example initiate polymerization at more than one site, so that the resulting polymer is branched or star-shaped, having the ligand at the apex of the branches. Suitable ligands also include at least two metal-binding centres. A ligand having a greater number of metal-binding centres may bind a metal atom more strongly than one with a lesser number of metal-binding centres. The term ‘denticity of ligand’ may be used in the art to describe this relationship.

The terms “chelator”, or “chelating agent” generally refer to a ligand capable of reversibly binding a metal ion, resulting in formation of at least two coordinate chemical bonds. The formation of such a bond may be referred to as “chelation”. The resulting ligand bound to a metal ion is referred to as a “metal complex”. A chelating agent may include a dentate structure and may be referred to as monodentate, bidentate, tridentate, tetradentate, and the like depending on the number of electron pair donating groups present—one, two, three, four and the like, respectively. Metal complex stability may be influenced by, for example, the size of the metal ion, size of the ligand, number of donating groups on the ligand, dipole moment of the ligand molecule and the like. The enhanced stability or ‘chelate effect’ found in coordination complexes involving chelating agents is known in the art, and a general discussion of the chelate effect may be found in, for example, Inorganic Chemistry, pp 527-534. 3^{rd} ed. J. E. Huheey, editor. Harper Collins, 1983.

“Ring-opening polymerization” generally refers to a type of addition polymerization, the end product of which is a polymer. An end of a growing polymer chain serves as a reactive centre capable of reacting with additional monomers to increase the chain length. A polymerization reaction, generally requires an initiator compound to provide the chemical environment necessary for reaction of monomers to form a polymer chain (‘polymerization’). For a ring-opening polymerization, the monomer is a cyclic compound. Examples of monomers that may be used in ring-opening polymerization include lactones, epsilon-caprolactone, substituted lactones, lactams, substituted lactams, anhydrides and the like. Ring-opening polymerizations are described generally in the art, see for example, U.S. Pat. No. 5,582,327; Amecke et al 1992. Clin Mater. 10:47-50; Grubbs and Tumas, 1989. Science 243:907-915; Liggins and Burt, 2002. Adv. Drug. Deliv Rev. 54:191-202; Albertsson and Varma, 2003. Biomacromolecules 4:1466-86.

During “step growth or condensation polymerization” monomers, oligomers and polymer chains combine by elimination of a small molecule to form a longer chain, ie. step growth. Each monomer contributing to this growth requires at least two or more functional groups such as diacids, diols, diamines, carbonates, isocyanates or a combination thereof (multi functional compounds produce cross linking). The reaction can be terminated using a ligand initiator or terminator to cap the chain end with the desired binding group. This process is also a “one pot” process to produce a polymer with a “claw.” Other variant reactions, necessary reaction conditions, monomers and methodologies will be known to one of skill in the art.

The choice of ligand may be made depending on the desired metal atom to be bound, the intended use, desired polymer, polymerization conditions that are suitable to the intended purpose, and the like. Selection of the ligand, polymer, reaction conditions and the like are within the scope of one of skill in the art.

The invention also provides methods of making such polymers. In some embodiments, the methods of making the polymers include a ‘one-pot’ ring-opening polymerization, using the ligand as an initiator or terminator of the polymerization reaction (a ‘ligand-initiator’ or a ‘ligand-terminator’).

In some embodiments, the ligand-initiator may include those illustrated in Table 3.

Ligand-Initiators for Ring-Opening Polymerization

TABLE 3
Ligands for use as initiators in ring-opening polymerization reactions

| Primary | | Alternate | Structure |
|---|---|---|---|
| name | Structure | names | No. |
| Ethyl2-((2- hydroxyethyl)(2- methylpyridin) amino)acetate | 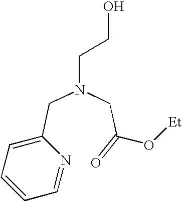 | N,N-((2- methylpyridine) ethylacetate) aminoethanol | 1 |
| Bis(picolylamine) ethanol | 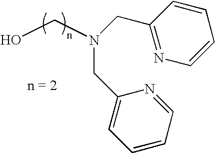 | N,N-bis(2- methylpyridine)-2- hydroxyethylamine; 2-bis(2- methylpyridine) aminoethanol; 2-N(2- CH₂Py)₂ethanol | 2 |
| Bis(picolylamine) propanol | 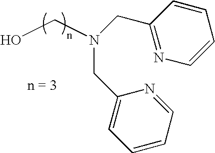 | 3-bis(2- methylpyridine) aminopropanol; N,N-bis(2- methylpyridine)-3- hydroxypropylamine 2-N(2-CH₂Py)₂propanol | 3 |
| Bis(picolylamine) butanol | 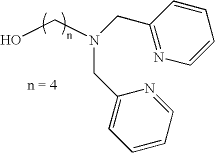 | N,N-bis(2- methylpyridine)-4- hydroxybutylamine 2-bis(2- methylpyridine) aminobutanol; 4-N(2- CH₂Py)₂butanol | 4 |
| Bis(picolylamine) pentanol | 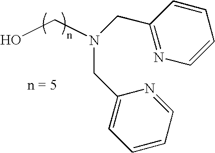 | N,N-bis(2- methylpyridine)-5- hydroxypentylamine 2-(bis(2-methyl pyridine)amino) pentanol; 5-N(2- CH₂Py)₂pentanol | 5 |
| Bis(picolylamine) hexanol | 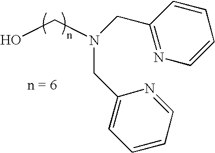 | N,N-bis(2- methylpyridine)-6- hydroxyhexylamine 2-(bis(2- methylpyridine) amino)hexanol 2-N(2- CH₂Py)₂hexanol | 6 |
| Iodination precursor of picolylamine | 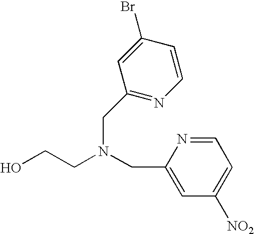 | 2-((2-methyl-4- bromo-pyridine)(2- methyl-4-nitro- pyridine)amino) ethanol | 6a |

Other embodiments of the invention include ligands such as bis(picolylamine)propanol, and those illustrated in Table 3. In other embodiments of the invention, other ligands may be used as ligand-initiators in a ring-opening polymerization. Examples of such ligand-initiators are illustrated in Table 4.

The examples provided in Table 4 describe molecules comprising a 6 —CH₂— alkyl chain. One of skill would be aware that this alkyl chain may be longer or shorter depending on the desired use of the ligand, or alternatively, the chain may be branched or have side chains of various descriptions such as aromatic or non-aromatic rings, for example.

TABLE 4
Ligands for use in alternate embodiments of the
invention. R = —OH, —SH or —NH_{2.}

| Structure | Structure No. |
|---|---|
| 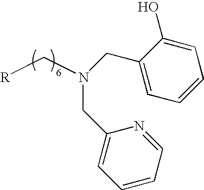 | 7 |
| 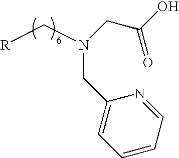 | 8 |
| 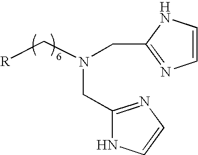 | 9 |
| 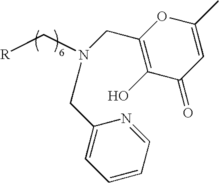 | 10 |
| 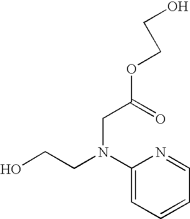 | 11 |
| 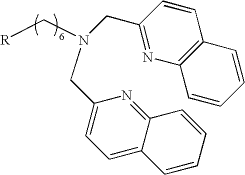 | 12 |

Some ligand-initiators may comprise functional groups that may need protecting before polymerization to prevent undesired side-reactions. Select functional groups may be left unprotected in all or a fraction of the ligand-initiators to permit appropriate ratios or species of side-reactions.

In some embodiments, the ligand-initiators (e.g., structure 12) are fluorescent, even when bound to metals.

In another embodiment of the invention, ligand-initiators illustrated in Table 3 may be used as initiators of ring-opening lactone polymerization, to yield poly(lactide) (PLA) having at one end the ligand. Examples of such ligand-polymers are illustrated in Table 5, formula 1-5.

TABLE 5
Ligand-polymers

| | | Alternate naming |
|---|---|---|
| Formula | Structure | reference |
| 1 | 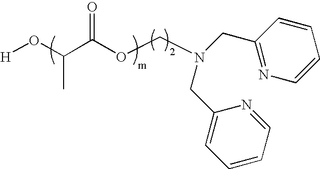 | PLA—OC₂N₃ |
| 2 | 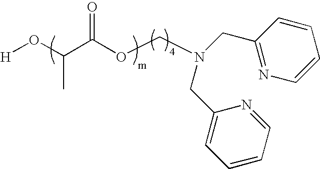 | PLA—OC₄N₃ |
| 3 | 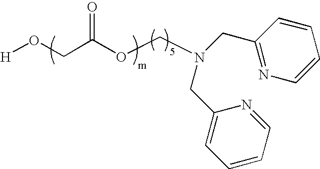 | PLA—OC₅N₃ |
| 4 | 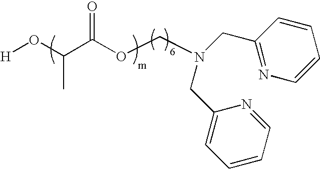 | PLA—OC₆N₃ |
| 5 | 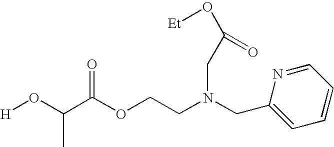 | PLA—OC₂N₂O |
| 6 | 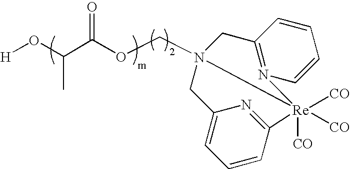 | PLA—OC₂N₃Re(CO)₃ |
| 7 | 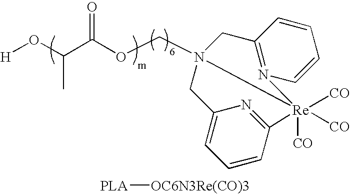 | PLA—OC₆N₃Re(CO)₃ |

Therefore, the invention provides in part polymers having a metal binding ligand at one or more termini.

In some embodiments, the ligand-polymer may also be coordinated with a metal atom. A compound, such as a metal salt, comprising the metal atom of interest, may be combined with the ligand-polymer in a reaction vessel, and the reaction solvent removed.

Therefore, the invention provides in part for ligand-polymers comprising coordinately-bound metal atoms.

Uses of Ligand-Polymers

The polymers comprising a ligand and a metal atom described in various embodiments of the invention may be used to manufacture, or in the manufacture of, an implant or an implantable material, such as prosthetics, ‘seeds’ or other small radioactive sources placed within tissues, e.g. for brachytherapy or microspheres injected in the circulation. The implantable material may be comprised of biocompatible materials including glass, some metals, some plastics or some polymers. Alternatively, the implantable material may be made of a biocompatible polymer. Other examples of such polymers may include chitin, chitosan, polysaccharide derivatives, proteins and other biological polymers, produced by plants or animals, polyanhydrides, polyurethanes, polycarbonates, and derivatives thereof, including other biodegradable or non-biodegradable polymers.

Ligand-polymers according to some embodiments of the invention may comprise one or more monomer species. Examples of such monomer species include lactide monomers, glycolides, s-caprolactones, hydroxybutyrates, sugars, isocyanates, polyoles, anhydrides, polyamines, lactams, lactones and the like.

In other embodiments, block co-polymers or amphipathic diblock copolymers may be synthesized.

The term ‘amphipathic diblock copolymer’ as used herein refers to a polymer including two chains of differing polymers. One polymer is hydrophobic, and the second is hydrophilic. Examples of hydrophobic polymers may include but are not limited to polylactic acid, polylactic-co-glycolic acid, polycaprolactone, polyhydroxybutyrate and polymethylmethacrylate. Examples of hydrophilic polymers may include but are not limited to methoxypolyethylene glycol (MePEG), polyethylene glycol (PEG), polyacrylic acid and polysaccharides.

Ligand-polymers according to some embodiments of the invention may be cast in a mould or on a template to provide a polymer material of a desired shape. Elasticizing or plasticizing agents may be incorporated into the ligand-polymer to provide desired physical characteristics, such as elasticity or flexibility, or to alter the degradation profile of a biodegradable ligand-polymer.

The terms ‘plasticizer’, ‘plasticizing agent’, ‘elasticizer’ or ‘elasticizing agent’, as used herein refer to a compound, for example an organic polymer, that, when combined with the parent material, confers elasticity or elastic properties such as stretching or flexibility. Examples of elasticizing agents used herein may include methoxypolyethylene glycol (MePEG), polyethylene glycol (PEG) and amphipathic diblock copolymers. Methods for preparing the elasticizing agents such as amphipathic diblock copolymers are described (Letchford et al, 2004. Colloids and Surface B: Biointerfaces 35:81-91).

Methods for preparing PLGA/elasticizing agent solutions or suspensions that may be cast into a polymeric barrier composition are described in PCT application WO 2006/045183, and in Jackson et al., 2004. Int J. Pharm 283:97-109. PLGA of the desired lactic acid:glycolic acid ratio may be combined with an elasticizer in a hydrophobic solvent. Examples of lactic acid:glycolic acid ratios may range from about 100:0 to about 0:100. By changing this ratio, polymers of longer or shorter chain length may be made. Other examples of methods for forming polymeric barrier compositions will be known to one of skill in the art.

Radiopharmaceuticals and Metallopharmaceuticals

The term “metallopharmaceutical” generally refers to a composition comprising at least one metal atom, that may be used for diagnosis and/or therapeutic treatment of a disease in a subject. Metal atoms that may be used in the preparation of a metallopharmaceutical may include, but are not limited to isotopes of Re, Tc, Cu, Ga, In, Y or lanthanide series metals, for example, La, Pr, Nd, Sm, Eu, Yb, Tb, Ho, Dy, Er, Tm, Lu, or other metal atoms such as Ti, V, Cr, Mo, W, Mn, Tc, Fe, Ru, Co, Ni, Pt, Cu, Ag, Au, Zn, Cd, Hg, Tl, Sb, Al, Pd, Rh, Zr, Bi and the like. The use of a particular element over another may be influenced by availability, cost, suitability to a particular application, disease state, use or target tissue, and the like, determination of which is within the skill of one versed in the art, for example, a pharmacist or other medical practitioner, or other skilled individual involved in the production of a metallopharmaceutical.

The term “radiopharmaceutical” generally refers to a radioactive compound that may be used for diagnosis and/or therapeutic treatment of a disease in a subject. The radioactive component of the radiopharmaceutical may be a radioactive element, for example radioactive metal, or a compound incorporating a radioactive element, or an implantable material incorporating a radioactive element. Radioactive metals that may be used in the preparation of a radiopharmaceutical may include, but are not limited to Cr-51, Co-57, Co-60, Cu-64, Cu-67, Ga-67, Ga-68, Y-90, Tc-99m, In-111, In-113, Tb-149, Sm-153, Gd-155, Gd-157, Dy-165, Ho-166, Er-169, Lu-177, Re-186, Re-188, At-211, Bi-212, Bi-213, Ra-223, Ac-225, Fm-255 or the like.

Metal atoms may be bound by the ligand of the ligand-polymer. Examples of Re-bound ligand-polymers are illustrated in Table 5, formula 6 and 7. In alternate embodiments of the invention, metal atoms that may be bound by the ligand of the ligand-polymer may include isotopes of Re, Tc, Cu, Ga, In, Y or lanthanide series metals, for example, La, Pr, Nd, Sm, Eu, Yb, Tb, Ho, Dy, Er, Tm, Lu, or other metal atoms such as Ti, V, Cr, Mo, W, Mn, Tc, Fe, Ru, Co, Ni, Pt, Cu, Ag, Au, Zn, Cd, Hg, Tl, Sb, Al, Pd, Rh, Zr, Bi and the like.

The efficiency of chelation of the metal atom in the ligand of the polymer may be determined by, for example, thin-layer chromatography (TLC). One example of a method for this TLC determination may be found in Yu et al, 2005 (supra). Other methods will be known to those of skill in the art.

The in vitro stability of the chelation of the metal atom in the ligand of the polymer may be determined by, for example, testing by incubation in PBS in the presence of biological fluids, such as serum. One example of such a method is described in Yu et al, 2005 (supra). Other methods will be known to those of skill in the art.

Polymer stability, particular polyester polymers which are sensitive to extreme pH changes, may be tested for the stability of the metal complex by, for example, performing a cysteine/histidine challenge. These and other methods will be known to those of skill in the art, and are described in, for example, Von Guggenberg et al 2004. Bioconjugate Chem. 15:864.

A subject may refer to a human, or a primate, or another mammal such as a rat, mouse, cat, dog, sheep, horse, cow, llama or goat. A subject may also include a non-mammal animal such as a bird, fish, worm, frog or other amphibian, or a reptile. The subject may be healthy, or may be in need of treatment for a disease or condition, or may be suspected of having a disease or condition, or in need of diagnosis of a disease or condition.

The use of a particular element over another may be influenced by availability, cost, suitability to a particular application, half-life, disease state, use or target tissue, and the like, determination of which is within the skill of one versed in the art, for example, a pharmacist or other medical practitioner, or other skilled individual involved in the production of a radiopharmaceutical.

The basis of utility or suitability for a particular use of a metallopharmaceutical or a radiopharmaceutical may not be based on pharmacologic action per se, but on the physical properties of the metal or radioactive atoms themselves, for example the half-life (t ½), type of radioactive decay or particle emission or the like.

In alternative embodiments of the invention, the ligand-polymers may be molded, cast or formed into radioactive biodegradable threads (for example to be used in surgery), as rods (e.g. for prostate cancer treatment), as mats or sheets (e.g., to be inserted into the resection wound of brain and breast tumours, or to be placed on skin cancer), as gels (for other local tumour treatments), and also as coatings of implants.

In alternative embodiments of the invention, the ligand-polymers may be used as therapeutics, for example, for nuclear medicine, e.g., for early detection of diseases and radiotherapy of cancers, for controlled drug delivery, implants, or for surgical dressings.

In alternative embodiments, rhenium-loaded polymer may be used as a contrast agent—for example when polymer stents are implanted. The rhenium with its high Z=75 makes it a potentially good contrast agent for x-ray imaging in the operating room during stent implantation, etc.

In another embodiment, such shaped polymers may contain lesser amounts of activity preferably gamma emitting radioisotopes, and then be used as markers for gamma camera imaging; other diagnostic or therapeutic uses in the form of micelles, liposomes and nanoparticles are also possible. The level of radioactivity incorporated by the ligand-polymer may be adjusted by altering the ratio of radioactive to non-radioactive isotope in the metal atoms to be chelated by the ligand-polymer.

Microspheres of polylactic acid polymers, or other polymers of the instant invention may be produced using methods known in the art, for example the methods described by Freitas et al 2005. J Control Release 102, 313-32.

Such labelled microspheres may be used in radiation synovectomy, tracing or brachytherapy, according to methods known to those of skill in the art.

Alternately, such labelled microspheres may be used as contrast media for the labelling of phagocytic cells. Such methods may be useful for visualizing inflammatory lesions that may be difficult to identify in conventional imaging techniques (Yang et al 1994. Investigative Radiology 29:S271-S274). Such labelled microspheres may also be useful to label cells within a body for migration studies, for example stem cells. Such cells may be ‘fed’ the labelled microspheres, and may allow for the cells to be followed or monitored with respect to uptake, location and movement in a patient.

In another embodiment of the invention, magnetic particles may be incorporated into the microspheres. In this way, specific tissue sites or tumours, for example, could be targeted by placing a magnet above the tumour, and then injecting the radioactive-labelled microspheres into a patient's blood supply.

In another embodiment of the invention, the ligand-polymer may be used to chelate excess metals in a subject. An individual contaminated with radioactivity may be treated with the ligand-polymer, which could ‘mop-up’ the metal atoms. Therapeutically, this might for example be helpful in the treatment of badly healing wounds, where an excess of zinc-dependent matrix metalloproteinases leads to chronic disease. Specifically binding the zinc with the ligand polymer of the instant invention would stop the action of the metalloproteinases and allow healing to occur. In some embodiments, the invention includes chelation therapy where the ligand-polymer is not pre-bound to metal.

In another embodiment, such ligand-polymers may have use in decontaminating equipment, water or other substances that could be filtered through, washed over or have passed through materials comprising a ligand-polymer of the instant invention.

In another embodiment, such ligand-polymers may be used to concentrate radioactive waste, for example from a patient undergoing radiopharmaceutical therapy or diagnosis. The metal atom may be removed from the patient's bodily waste or fluids and collected for safe disposal. Alternately, technical applications of the ligand-polymers include the recovery and concentration of radionuclides from nuclear waste and nuclear plant efflux for safe storage, recycling and reuse.

Pharmaceutical Compositions and Administration

Radiopharmaceuticals, metallopharmaceuticals and ligand-polymers according to various embodiments of the invention may be generally described as compositions or compounds. The compositions of the present invention may be admixed with any suitable pharmaceutical carrier or salt. “Pharmaceutically acceptable salts” refers to the relatively non-toxic, inorganic and organic acid addition salts, and base addition salts, of compounds of the present invention. These salts can be prepared in situ during the final isolation and purification of the compounds. In particular, acid addition salts can be prepared by separately reacting the purified compound in its free base form with a suitable organic or inorganic acid and isolating the salt thus formed. Exemplary acid addition salts include the hydrobromide, hydrochloride, sulfate, bisulfate, phosphate, nitrate, acetate, oxalate, valerate, oleate, palmitate, stearate, laurate, borate, benzoate, lactate, phosphate, tosylate, citrate, maleate, fumarate, succinate, tartrate, naphthylate, mesylate, glucoheptonate, lactiobionate, sulphamates, malonates, salicylates, propionates, methylene-bis-β hydroxynaphthoates, gentisates, isethionates, di-p-toluoyltartrates, methanesulphonates, ethanesulphonates, benzenesulphonates, p-toluenesulphonates, cyclohexylsulphamates and quinateslaurylsulphonate salts, and the like. See, for example S. M. Berge, et al., “Pharmaceutical Salts,” J. Pharm. Sci., 66, 1-19 (1977) which is incorporated herein by reference. Base addition salts can also be prepared by separately reacting the purified compound in its acid form with a suitable organic or inorganic base and isolating the salt thus formed. Base addition salts include pharmaceutically acceptable metal and amine salts. Suitable metal salts include the sodium, potassium, calcium, barium, zinc, magnesium, and aluminum salts. The sodium and potassium salts are preferred. Suitable inorganic base addition salts are prepared from metal bases which include sodium hydride, sodium hydroxide, potassium hydroxide, calcium hydroxide, aluminum hydroxide, lithium hydroxide, magnesium hydroxide, zinc hydroxide. Suitable amine base addition salts are prepared from amines which have sufficient basicity to form a stable salt, and preferably include those amines which are frequently used in medicinal chemistry because of their low toxicity and acceptability for medical use, for example, ammonia, ethylenediamine, N-methyl-glucamine, lysine, arginine, ornithine, choline, N,N′-dibenzylethylenediamine, chloroprocaine, diethanolamine, procaine, N-benzylphenethylamine, diethylamine, piperazine, tris(hydroxymethyl)-aminomethane, tetramethylammonium hydroxide, triethylamine, dibenzylamine, ephenamine, dehydroabietylamine, N-ethylpiperidine, benzylamine, tetramethylammonium, tetraethylammonium, methylamine, dimethylamine, trimethylamine, ethylamine, basic amino acids, e.g., lysine and arginine, and dicyclohexylamine, and the like.

The compositions of the present invention may be administered by any suitable route including injection, skin patch, or orally. Thus, in one aspect, the present invention provides pharmaceutical compositions for human or veterinary medical use comprising a ligand-polymer composition together with one or more pharmaceutically or physiologically acceptable buffers, carriers, excipients, or diluents, and optionally, other therapeutic agents. It should be noted that compounds of the present invention can be administered individually, or in mixtures comprising two or more compounds. The present invention also encompasses the use of a ligand-polymer composition for the preparation of a medicament for the prevention or treatment of an infection or pathology, or a disease state or condition.

The compounds of the present invention can be administered in pharmaceutically or physiologically acceptable solutions that can contain pharmaceutically or physiologically acceptable concentrations of salts, buffering agents, preservatives, compatible carriers, diluents, excipients, dispersing agents, etc., and optionally, other therapeutic ingredients. The compounds and compositions of the present invention can thus be formulated in a variety of standard pharmaceutically acceptable parenteral formulations as would be known to one of skill in the art.

The pharmaceutical compositions of the present invention can contain an effective amount of the presently disclosed compounds or compositions, optionally included in a pharmaceutically or physiologically acceptable buffer, carrier, excipient, or diluent. The term “pharmaceutically or physiologically acceptable buffer, carrier, excipient, or diluent” means one or more compatible solid or liquid fillers, dilutants, or encapsulating substances that are suitable for administration to a human or other animal. The term “carrier” denotes an organic or inorganic ingredient, natural or synthetic, with which the active ingredient is combined to facilitate the application. The components of the pharmaceutical compositions are capable of being commingled with the polymers of the present invention, and with each other, in a manner such that there is no interaction that would substantially impair the desired pharmaceutical efficiency of the active compound(s).

Compositions suitable for parenteral administration conveniently comprise sterile aqueous preparations, which can be isotonic with the blood of the recipient. Among the acceptable vehicles and solvents are water, Ringer's solution, and isotonic sodium chloride solution. In addition, sterile, fixed oils are conventionally employed as a solvent or suspending medium. For this purpose, any bland fixed oil can be employed, including synthetic mono- or diglycerides. In addition, fatty acids such as oleic acid are useful in the preparation of injectables. Carrier formulations suitable for subcutaneous, intramuscular, intraperitoneal, intravenous, etc. administrations can be found in Remington: The Science and Practice of Pharmacy, 19th Edition, A. R. Gennaro, ed., Mack Publishing Co., Easton, Pa., (1995, which is incorporated herein by reference).

The compositions can be conveniently presented in unit dosage form or dosage unit form, and can be prepared by any of the methods well known in the art of pharmacy. All methods include the step of bringing the compound into association with a carrier that constitutes one or more accessory ingredients. In general, the compositions are prepared by uniformly and intimately bringing the compound into association with a liquid carrier, a finely divided solid carrier, or both. Compounds of the present invention can be stored lyophilized, and provided as a kit for admixing prior to use.

Other delivery systems can include time-release, delayed-release, or sustained-release delivery systems. Such systems can avoid repeated administrations of the compositions of the present invention, increasing convenience to the subject and the physician.

Delivery systems may also include non-polymer systems such as: lipids, including sterols such as cholesterol, cholesterol esters, and fatty acids or neutral fats such as mono-, di-, and tri-glycerides; hydrogel release systems; silastic systems; peptide-based systems; wax coatings; compressed tablets using conventional binders and excipients; partially fused implants; and the like.

Determination of the optimal amount of compound to be administered to human or animal subjects for diagnostic, imaging or therapeutic purposes, as well as methods of administering therapeutic or pharmaceutical compositions comprising such compounds, is well within the skill of those in the pharmaceutical, medical, and veterinary arts. Dosing of a human or animal subject is dependent on the nature of the application or procedure to be performed and the subject's condition, body weight, general health, sex, diet, time, duration, and route of administration, rates of absorption, distribution, metabolism, and excretion of the compound, combination with other drugs, the responsiveness of the pathology or disease state being treated (if applicable), and may readily be optimized to obtain the desired level of effectiveness. The course of treatment can last from several days to several weeks or several months, or until a cure is effected or an acceptable diminution or prevention of the disease state is achieved. Optimal dosing schedules may be calculated from measurements of immune response in the body of the patient in conjunction with the effectiveness of the treatment. Persons of ordinary skill can easily determine optimum dosages, dosing methodologies, and repetition rates. Optimum dosages can vary depending on the potency of the composition, half-life of the radiopharmaceutical, type of polymer used and other factors considered in determining dosages as described. Effective amounts of the present compounds or compositions, delivery vehicles containing these compounds or compositions and use or treatment protocols, can be determined by conventional means. For example, the medical or veterinary practitioner can commence treatment with a low dose of the compound in a first subject, or first set of subjects, and then increase the dosage, or systematically vary the dosage regimen in a second or subsequent subject, or second or subsequent set of subjects, monitor the effects thereof on the subjects, and adjust the dosage or treatment regimen to maximize the desired effect. Further discussion of optimization of dosage and treatment regimens can be found in Benet et al., in Goodman & Gilman's (1996, The Pharmacological Basis of Therapeutics, Ninth Edition, Hardman et al., Eds., McGraw-Hill, New York, Chapter 1, pp. 3-27; which is incorporated herein by reference) or Bauer (L. A. Bauer, 1999, in Pharmacotherapy, A Pathophysiologic Approach, Fourth Edition, DiPiro et al., Eds., Appleton & Lange, Stamford, Conn., Chapter 3, pp. 21-43; which is incorporated herein by reference).

A variety of administration routes are available. The particular mode selected will depend upon which compound is selected, the particular condition being treated, and the dosage required for therapeutic efficacy. Generally speaking, the methods of the present invention can be practiced using any mode of administration that is medically acceptable, meaning any mode that produces effective levels of an immune response without causing clinically unacceptable adverse effects. Preferred modes of administration are parenteral routes, although oral administration can also be employed. The term “parenteral” includes subcutaneous, intradermal, intravenous, intramuscular, or intraperitoneal injection, or infusion techniques.

Kits

In another embodiment of the invention, the ligand-polymers, or implantable materials comprising the ligand-polymers may be incorporated into a kit. Such a kit may comprise a buffer or buffers, microspheres or other polymeric shapes comprising a ligand-polymer and instructions for chelating metal atoms by the microspheres. Additionally, such a kit may include devices to facilitate delivery of the chelated ligand-polymer material to the patient, such as a catheter or syringe.

### EXAMPLES

### Materials and Methods

All chemicals were purchased from Sigma Aldrich and used without purification unless mentioned. (NH₄)₂ReBr₃(CO)₃, 2-bis(picolylamine)ethanol, 4-bis(picolylamine)butanol, 5-bis(picolylamine)pentanol, 6-bis(picolylamine)hexanol were synthesized as reported in the literature with minor modifications (Botha et al 1998. Inorganic Chemistry 37:1609; Hong et al 2002 Macromolecules 35:7592; Groves et al Inorganic Chemistry 1993, 32, 3868; Banerjee et al. 2005. Dalton Transactions 24: 3886-3897). As a brief example of the method, 2-N(2-CH₂Py)₂ethanol (bis(picolylamine)ethanol) was synthesized by the addition of 2-picolyl chloride to ethanol amine in a 2:1 ration in the presence of strong base or by coupling 2-pyridine carboxaldehyde and ethanolamine and further reduction by sodium (triacetoxy)borohydride. The final product was purified by column chromatography using basic alumina and 5% MeOH in chloroform and characterized by ¹H NMR. All other ligands/initiators were synthesized in a similar manner. These compounds were used as an initiator alcohol in the polymerization of L-lactide.

All solvents were dried and kept under Ar (Praxair). All syntheses were carried out under Ar using standard Schlenk techniques. ¹H NMR spectra were recorded on a Bruker AV-300 or AV-400 at 300.13 or 400.13 MHz. ¹³C NMR spectra were recorded on a Bruker AV-400 at 100.62 MHz. The 2D COSY and HMQC experiments were recorded on a Bruker AV-400 spectrometer at 400.13 MHz (100.62 MHz for C). MALDI-TOF mass spectra were obtained on a Bruker Biflex IV MALDI-TOF equipped with nitrogen laser. Infrared spectra were recorded on a FTIR Bomen MB-110 spectrophotometer as KBr pellets. GPC was performed on a Waters Millennium HPLC-GPC system with columns: 7.8×300 mm (Styragel HR1 in tandem with Styragel HR3), chloroform solvent at a flow rate of 1 ml/min with 50 μl injection volume and refractive index detection. NMR solvents were from Cambridge Isotope Laboratories.

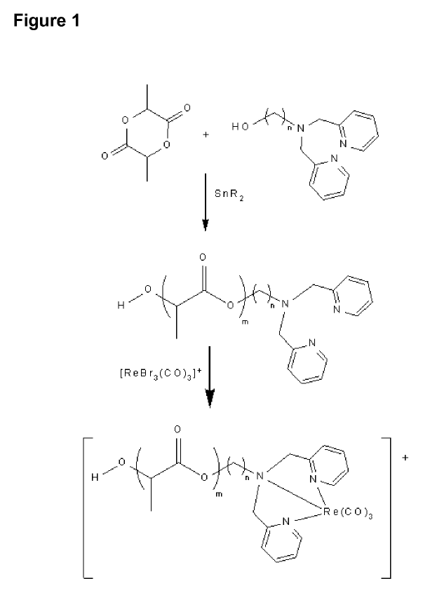

Ring opening polymerization of L-Lactide was carried out using initiators having a hydroxyl functionality, as illustrated generally in FIG. 1, where “m” and “n” can be any number. In some embodiments, “n” can be any number from 1 to 6, inclusive. The initiators also had a ligand functionality for binding metal ions. Reactions were done using a 1:20 initiator to monomer molar ratio.

### Example 1

### Ring-Opening Polymerization of L-Lactide Using Ligand Initiator 2-N(2-CH₂Py)₂Ethanol to Provide PLA-OC₂N₃ (Formula 1)

L-Lactide (1.20 g, 8 mmol); recrystallized in EtOAc and 2-bis(picolylamine)ethanol (114 mg, 0.5 mmol) were put in a 3 neck round bottom flask equipped with a condenser. The flask was evacuated (and kept under vacuum for 15 min) and filled with Ar for 3 times before toluene (10 ml) was added with stirring. Stannous octoate (˜50 μl, 50%) was added to the reaction flask. The flask was then immersed into a preheated 125° C. oil bath, heated for 3 h, cooled to room temperature and the solvent removed. The resulting solid was redissolved in 10 ml of CH₂Cl₂ and the resulting solution was washed with 10 ml of 0.1 M HCl, 10 ml saturated brine and 2×15 ml of H₂O. The organic phase was dried over anhydrous Na₂SO₄. After filtration and removal of solvent the final product was washed with MeOH and dried under vacuum (650 mg, 72%). ¹H NMR (CDCl₃, 300 MHz): δ 1.45 (d, CH₃CHOH), 1.5 (d, CH₃), 2.85 (t, CH₂, H7,7′), 3.84 (s, CH₂, H5,5′/6,6′), 4.2 (m, CH₂, H8,8′), 4.34 (q, CH₃CHOH), 5.15 (q, CH), 7.15 (t, py H2,2′), 7.48 (d, py H4,4′), 7.65 (t, py H3,3′), 8.5 (d, py H1,1′). IR (KBr disk, cm⁻¹): 3490 (b, ν_{OH}), 1758 (ν_{C═O}). MS (MALDI-TOF): m/z 1399, 1543, 1687, 1832, 1976, 2120, 2264, 2408, 2250, 2694.

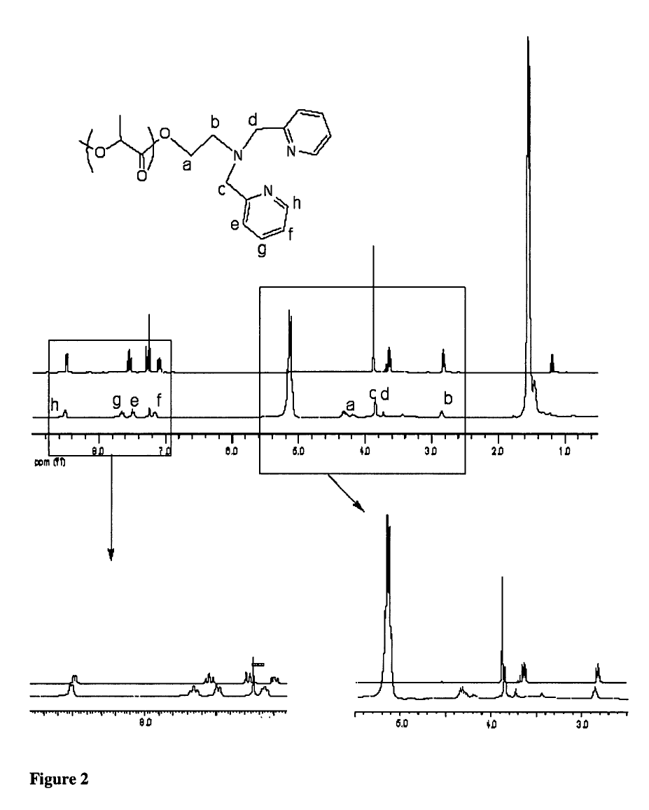

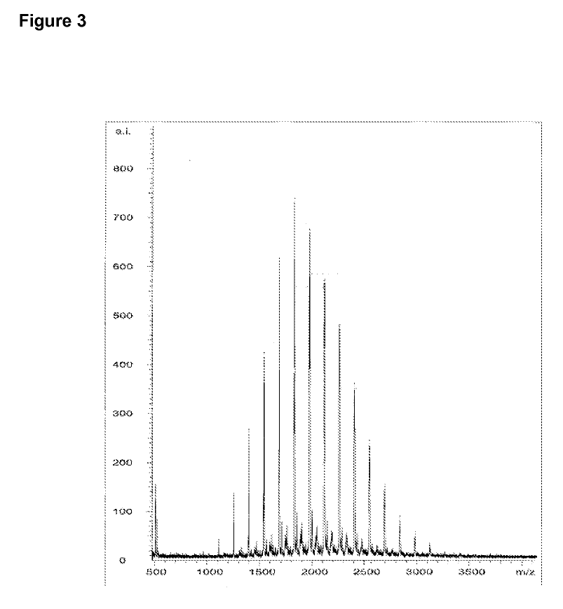

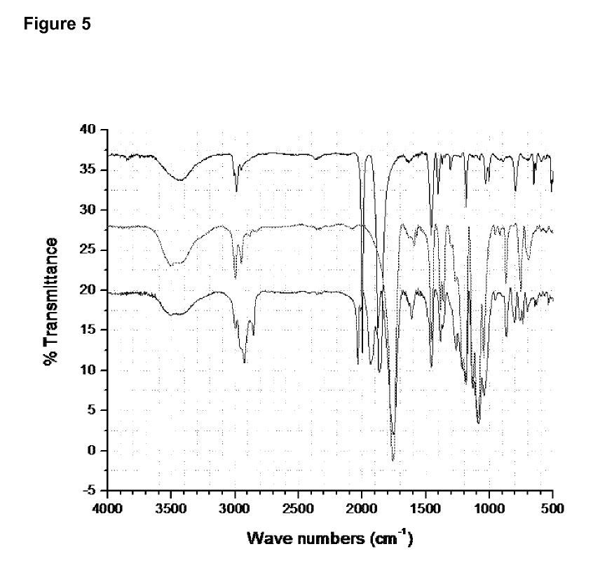

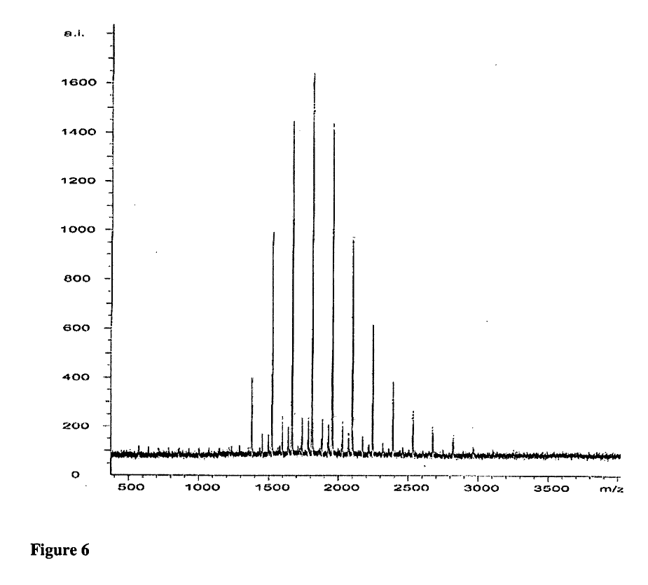

¹H NMR of PLA-OC₂N₃ (formula 1) is shown in FIG. 2, MALDI-TOF MS spectra of PLA-OC₂N₃ (formula 1) is shown in FIG. 3. IR spectra of PLA-OC₂N₃ (formula 1) is shown as the middle tracing in FIG. 5.

FIG. 3 shows the MALDI-TOF MS for 1, the peaks correspond to even-numbered oligomer chains of about 16-36 units with bis(picolylamine)ethanol and hydroxyl end caps as expected on the basis of ring-opening polymerization. The mass then can be calculated based on equation 1 (x=number of monomers). The peak at m/z 1832, for example, corresponds to an oligomer chain of 22 repeat units. All other mass spectra were similarly assigned.
M=72x+initiator+H end group+H⁺ Equation 1

Molecular weight distributions in polymers can also be calculated using standard equations 2 and 3.

$$\begin{matrix}{M}_{n} = \frac{{\sum }_{l} {N}_{i} {M}_{i}}{{\sum }_{l} {N}_{i}} & Equation 2 \\ {M}_{w} = \frac{{\sum }_{i} {N}_{i} {M}_{i}^{2}}{{\sum }_{i} {N}_{i} {M}_{i}} & Equation 3\end{matrix}$$

The MALDI data were fitted to these equations where N is the number of molecules with molecular weight M and i runs over all oligomer ions (FIG. 3 given on the ordinate). Table 6 presents the data obtained based on the above formulation.

The molecular weights (MW) of the synthesized polymers were calculated relative to polystyrene standards using GPC (Table 6).

TABLE 6
Summary of molecular weights (Da) for different
uncoordinated and coordinated ligand-polymers.

| Compound/Formula | M_{(NMR)} | M_{n (MALDI)} | M_{w (MALDI)} | PDI^{a} | M_{(GPC)} |
|---|---|---|---|---|---|
| C2-1 | 1683 | 1973 | 2049 | 1.04 | 2371 |
| C4-2 | 1711 | 1697 | 1730 | 1.02 | 2880 |
| C6-4 | 1898 | 2285 | 2370 | 1.04 | 3980 |
| C2′-6 | 1878 | 1893 | 1944 | 1.03 | — |
| C4′-6a | 1826 | 2133 | 2159 | 1.01 | — |
| C6′-7 | 2368 | 2524 | 2561 | 1.02 | — |

^{a}PDI = polydispersity index

A plot of the log(MW) vs retention time of the polystyrene standards was used to calculate the MW of the unknown polymer-ligands. Since the monomer loading ratio is not too high, ¹H NMR can be used to gain valuable information on the MW of the synthesized polymers. The MW was calculated based on the integration numbers of the methine group in the polymer chain to the terminal methine. MALDI-TOF mass spectrometry, however, is the better technique for determining the true MW of these ligand-polymers since it shows a fingerprint of each oligomer chain and involves no referencing; the numbers are actual mass. The NMR and MALDI data are lower than the GPC data using polystyrene standards, a trend which has been observed for PLA before. The MALDI-TOF spectra of various polymer-ligands shows a molecular weight distribution of about 1-3 kD corresponding to oligomers distributed with monomer repeat units of as low as 12 and as high as about 36 depending on the ligand-polymer (compounds 1, 2, and 4). This range of MW is suitable for application with short-lived radioisotopes because MW is an important factor affecting the degradation rate of the polymers.

The IR spectra of the ligand-polymers show distinct signals for PLA with the signal absorption intensities in good agreement with that found in the literature, confirming again a successful polymerization. The signals for the ligand functionality (bis(picolylamine)alcohol) are mainly overlapped with the intense polymer backbone signals; however, the ring stretching signals are observed at about 1610 cm⁻¹.

### Example 2

### Ring-Opening Polymerization of L-Lactide Using Ligand Initiator 4-N(2-CH₂Py)₂Butanol to Provide PLA-OC₄N₃ (Formula 2)

Similar procedure as for Example 1, using 4-bis(picolylamine)butanol as the ligand-initiator in place of 2-bis(picolylamine)ethanol. ¹H NMR (CDCl₃, 300 MHz): δ 1.49 (d, CH₃CHOH), 1.52 (d, CH₃), 2.72 (b, CH₂, Ha,a′), 4.09 (t, CH₂, Hd,d′), 4.35 (q, CH₃CHOH), 5.14 (q, CH), 7.25 (t, py H2,2′), 7.74 (m, py H2,2′/H3,3′), 8.5 (d, py H1,1′). IR (KBr disk, cm⁻¹): 3450 (ν_{OH}), 1756 (ν_{C═O}). MS (MALDI-TOF): m/z 1137, 1281, 1426, 1570, 1714, 1858, 2002, 2146.

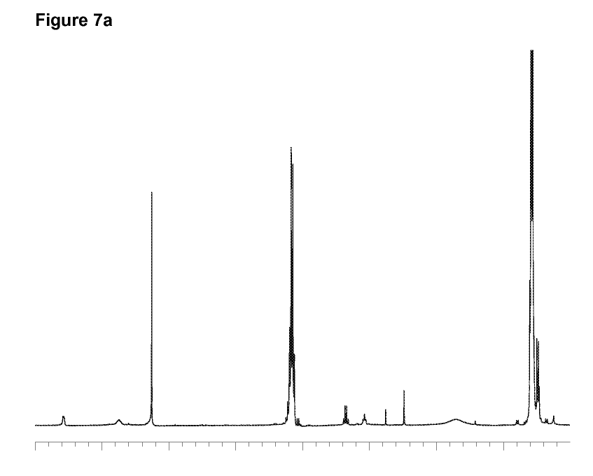

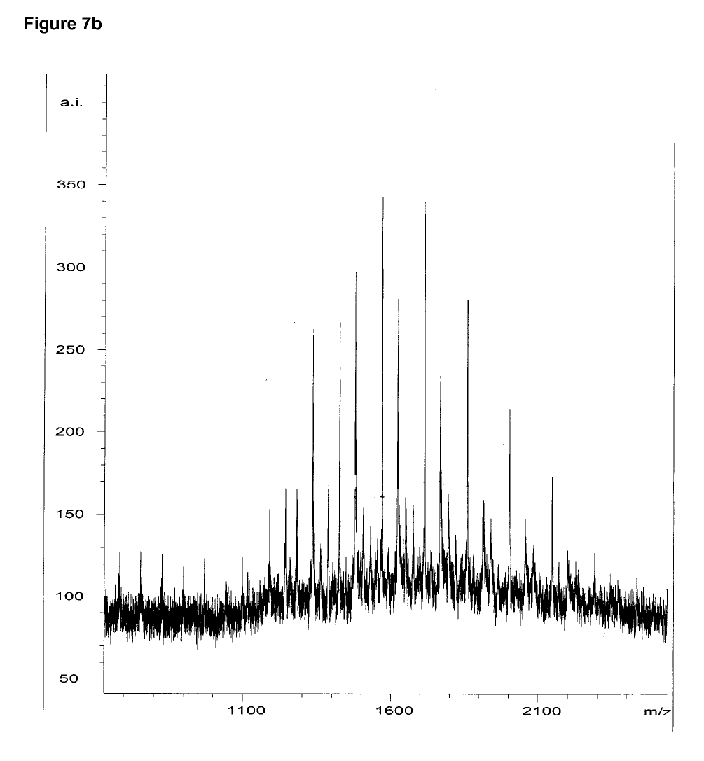

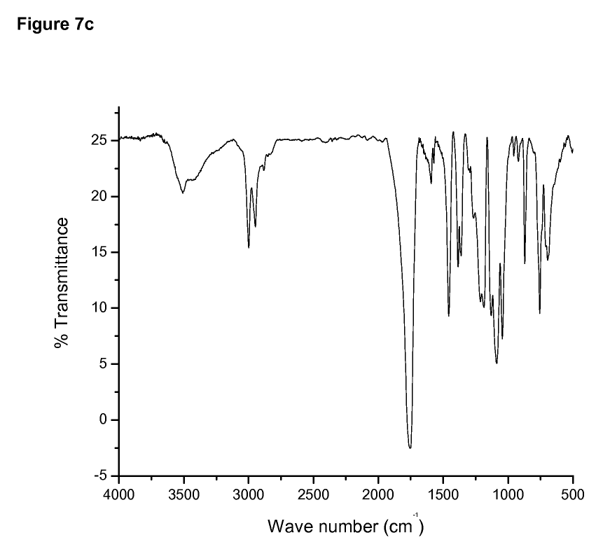

¹H NMR of PLA-OC₄N₃ (formula 2) is shown in FIG. 7a, MALDI-TOF MS is shown in FIG. 7b, IR spectra is shown in FIG. 7c.

### Example 3

### Ring-Opening Polymerization of L-Lactide Using Ligand Initiator 5-N(2-CH₂Py)₂pentanol to Provide PLA-OC₅N₃ (Formula 3)

Similar procedure as for Example 1, using 5-bis(picolylamine)pentanol as the ligand-initiator.

### Example 4

### Ring-Opening Polymerization of L-Lactide Using Ligand Initiator 6-N(2-CH₂Py)₂Hexanol to Provide PLA-OC₆N₃ (Formula 4)

Similar procedure as for Example 1, using 6-bis(picolylamine)hexanol as the ligand-initiator in place of 2-bis(picolylamine)ethanol. ¹H NMR (CDCl₃, 300 MHz): d 1.49 (d, CH₃CHOH) 1.54 (d, CH₃), 3.75 (s, H6,6′), 4.07 (t, CH₂, Ha,a′), 4.3 (m, CH₂ Hf,f′), 4.38 (q, CH₃CHOH), 5.15 (q, CH), 7.30 (t, py H 4,4′), 7.76 (m, py H 2,2′/3,3′), 8.52 (d, py H1,1′). IR (KBr disk, cm⁻¹): 3500 (ν_{OH}), 1758 (ν_{C═O}). MS (MALDI-TOF): m/z 1454, 1598, 1741, 1885, 2030, 2174, 2318, 2462, 2606, 2750.

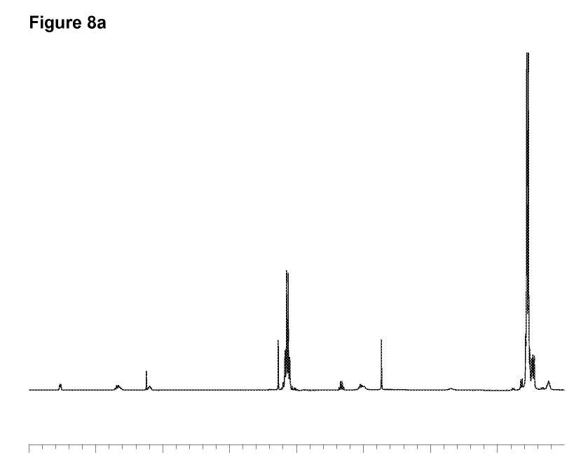

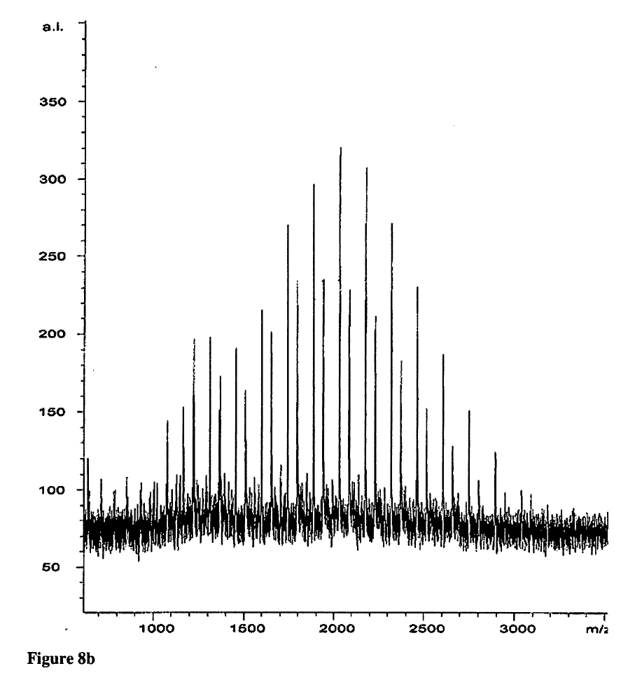

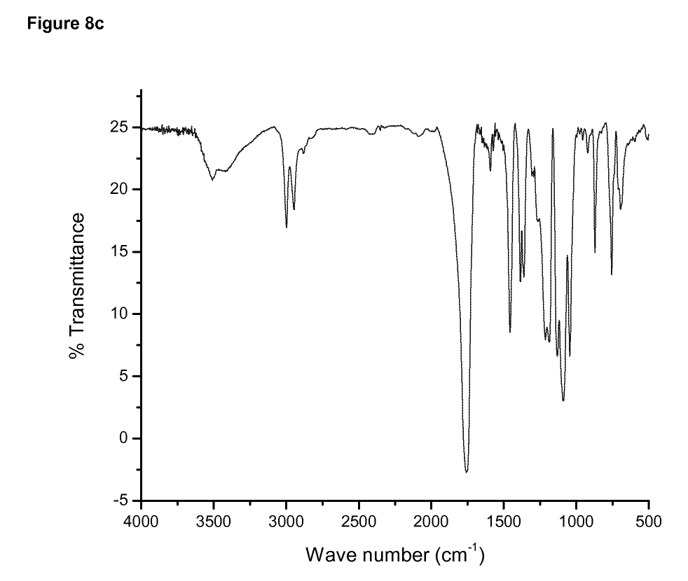

¹H NMR of PLA-OC₆N₃ (formula 4) is shown in FIG. 8a, MALDI-TOF MS is shown in FIG. 8b, IR spectra is shown in FIG. 8c.

### Example 5

### Ring-Opening Polymerization of L-Lactide Using Ligand Initiator HOEtN(2-CH₂Py)(CH₂COOEt) to Provide PLA-OC₂N₂O (Formula 5)

Lactide (1.36 g) recrystallized in EtOAc and HOEtN(2-CH₂C₆H₄)(CH₂COOC₂H₅) (See structure 1 in Table 3) (108.4 mg) were placed in a RBF under absolute conditions. Toluene 10 mL was added to the reaction flask. Stannous octoate (50% solution in dimethyl silane) was added to the reaction flask with stirring (3 drops). The RBF was the immerged into a preheated 125° C. oil bath. After 3 h stopped the heat, cooled to room temperature and removed the solvent under vacuum. The solid redissolved in CH₂Cl₂ and washed with 10 mL of 0.1 M HCl and 2×10 mL of H₂O. The organic phase was collected and dried over anhydrous Na₂SO₄. Removal of solvent afforded a light yellow solid.

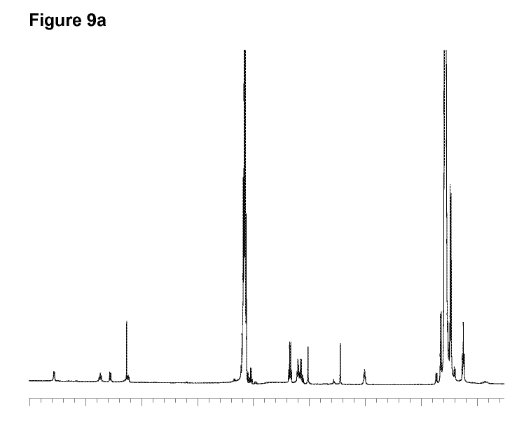

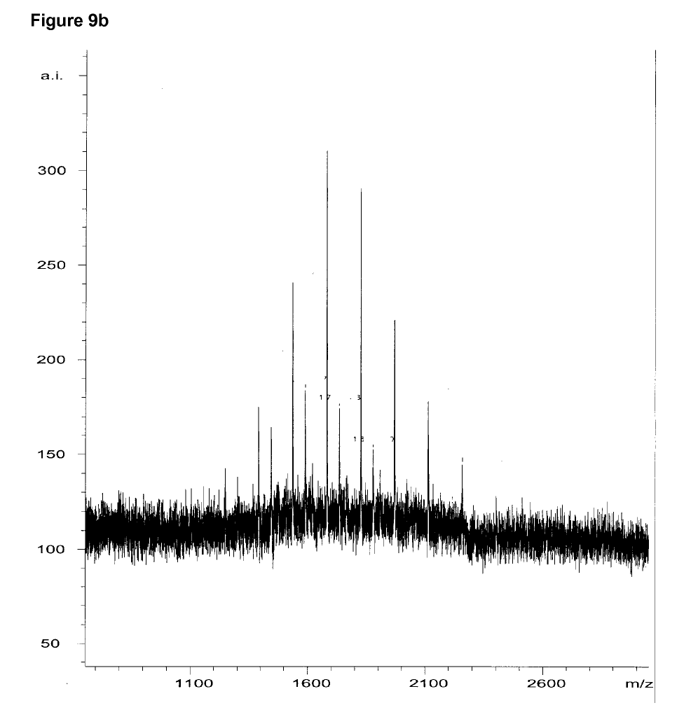

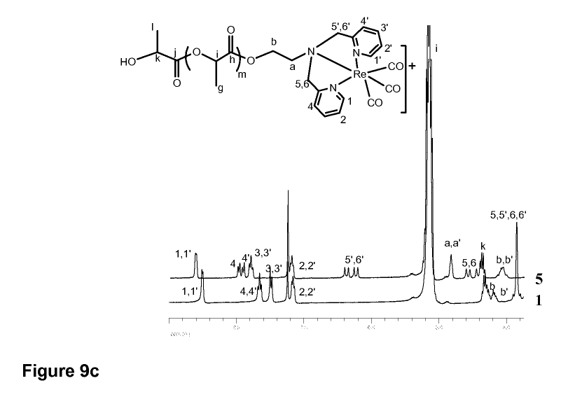

¹H NMR of PLA-OC₂N₂O (formula 5) is shown in FIG. 9a, MALDI-TOF MS is shown in FIG. 9b.

All compounds were characterized with NMR spectroscopy that provided the key proof of metal coordination. FIG. 9c shows the ¹H NMR spectrum of formula 5 in comparison with the unbound polymer-ligand. Although the resonances of the polymer backbone have not been affected, which confirms the pendant nature of the polymer chain, the spectrum clearly shows a lower symmetry of the binding (bis(picolyl)amine)ethanol moiety upon coordination to the Re(CO)₃ core. The polymer backbone has produced an asymmetric effect on the compound. Similar findings are reported for Re coordinated bis(picolylamine) with different backbones. The CH₂ protons on the ethyl next to the O (b,b′) are diastereotopic before ligand binding with signals at 4.1 and 4.3 ppm. Both signals are shifted slightly upfield after coordination. The CH₂ protons on the ethyl backbone next to the amine N (a,a′), however, show a significant downfield shift (2 ppm) upon coordination of the tertiary amine N to the rhenium metal ion. This is indicative of N3 ligand binding mode. A downfield shift is also observed for the proton resonances in the bis(picolyl)amine moiety. The two methylene groups on the pyridine rings show diastereotopic geminal protons (J=16 Hz) with the signals being shifted downfield (by 0.7 (5,6) and 2.2 (5′,6′) ppm) from the original polymer-ligand signal at δ 3.85. These four protons (5,5′, 6,6′) are clearly non-identical after coordination showing asymmetry in the polymer-complex structure. This might be due to rigidity of the ethyl backbone or the long-range polymer asymmetric influence that could enhance conformational restrictions. The pyridine proton signals are also shifted downfield. The ¹H NMR spectrum shows that the two pyridine rings are not equivalent with the 4,4′ pattern changing substantially to show two discrete doublets after metal binding.

### Example 6

### Metal Coordination, Reaction of PLA-Ligand with [ReBr₃(CO)₃]²⁺ Core: Syntheses of a Novel Rhenium/Polymer Conjugate Using PLA-OC₂N₃ to Provide PLA-OC₂N₃Re(CO)₃ (Formula 6)

PLA-OC₂N₃Re(CO)₃ (5). PLA-OC₂N₃ (1) (62.7 mg, 35 μmol) was dissolved in 5 ml of CH₂Cl₂ in a 3 neck round bottom flask. (NH₄)₂ReBr₃(CO)₃ (26 mg, 35 μmol) was first dissolved in 0.5 ml of MeOH and then diluted with 9.5 ml of CH₂Cl₂. The metal complex was added dropwise to the polymer solution under Ar with stirring. The temperature was increased to 45° C. and the light clear yellow solution started to reflux. After 3 h the solution was cooled to room temperature, the solvent was removed and MeOH was added to the remaining solid. After stirring in MeOH for a few minutes the mixture was filtered and the beige solid was dried under vacuum (56 mg, 89%). ¹H NMR (CDCl₃, 300 MHz): δ 1.47 (d, CH₃CHOH), 1.56 (d, CH₃), 4.03 (m, CH₂, H8,8′), 4.36 (q, CH₃CHOH), 4.47 (d, CH₂, H5,5′), 4.80 (t, CH₂, H7,7′), 5.15 (q, CH), 6.30 (d, CH₂, H6,6′), 7.19 (t, py H2,2′), 7.80 (t, py H3,3′), 7.95 (dd, py H4,4′), 8.6 (d, py H1,1′). IR (KBr disk, cm⁻¹): 3418 (V_{OH}), 2033 (ν_{C≡O}), 1930 (ν_{C≡O}), 1758 (ν_{C═O}). MS (MALDI-TOF): m/z 1376, 1522, 1666, 1810, 1954, 2098, 2242, 2388, 2532, 2676, 2820.

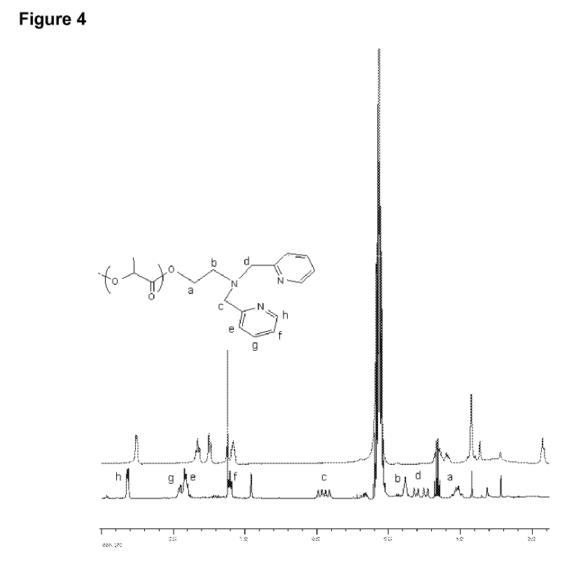

¹H NMR spectra of PLA-OC₂N₃Re(CO)₃ (formula 6) is shown in FIG. 4, IR spectra of PLA-OC₂N₃Re(CO)₃ (formula 6) are shown in FIG. 5, MALDI-TOF MS spectra of PLA-OC₂N₃Re(CO)₃ (formula 6) is shown in FIG. 6.

Coordination of PLA-OC₂N₃ to rhenium was performed using (NH₄)₂[ReBr₃(CO)₃] as the starting rhenium compound. Slow addition of the metal complex solution to the polymer solution in CH₂Cl₂ and heating afforded a yellow solution that upon removal of the residual solvent produced a beige solid. ¹H NMR of this compound illustrates the metal coordination (FIG. 4). The ¹H NMR spectrum shows a lower symmetry once the polymer is bound to the rhenium centre. A downfield shift is observed for the proton resonances in the pyridine rings (e, f, g, h), compared to that of the ligand-polymer by itself (FIG. 2). The CH₂ protons on the ethyl backbone (a, b) next to the amine N show a significant downfield shift upon coordination of the tertiary N to rhenium. The two methylene groups between the amine N and the pyridine ring (c, d) also are shifted from the original polymer signals.

The infrared spectrum of formula 6 (FIG. 5) also shows the two CO peaks characteristic of the Re(CO)₃ core at 1950 cm⁻¹ and 2030 cm⁻¹ (bottom tracing) well shifted from the Re starting material (1850, 2000 cm⁻¹, upper tracing) as expected upon Re coordination.

MALDI-TOF mass spectrum of the rhenium complex (FIG. 6) shows ideal isotope pattern for a Re/polymer conjugate since rhenium has 37% abundance of ¹⁸⁵Re and 63% natural abundance of ¹⁸⁷Re. The simulation mass spectrum matched the isotope pattern of the spectrum of PLA-OC₂N₃Re(CO)₃ (formula 6) confirming that each polymer chain has been coordinated to one Re only as expected. All peaks seem to be shifted by a mass of 270 that is the Re(CO)₃ core.

### Example 7

### Metal Coordination, Reaction of PLA-Ligand with [ReBr₃(CO)₃]²⁺ Core: Syntheses of a Novel Rhenium/Polymer Conjugate Using PLA-OC₆N₃ to Provide PLA-OC₆N₃Re(CO)₃ (Formula 7)

PLA-OC₆N₃ (formula 4) (52.2 mg) was dissolved in 3 ml of CH₂Cl₂ in a 3 neck RBF. (NH₄)₂ReBr₃(CO)₃ (26 mg, 34.8 μmol) was dissolved in 0.5 ml of MeOH first and added to 9.5 mL of CH₂Cl₂. The metal complex was added dropwise to the polymer solution under Argon. The temperature was increased to 50° C. and the light clear yellow solution started to reflux. The solution heated for 3 h. Once cooled to RT the solvent was removed and MeOH was added to the remaining solid. After stirring in MeOH for a few minutes the mixture was filtered and the beige solid dried under vacuum.

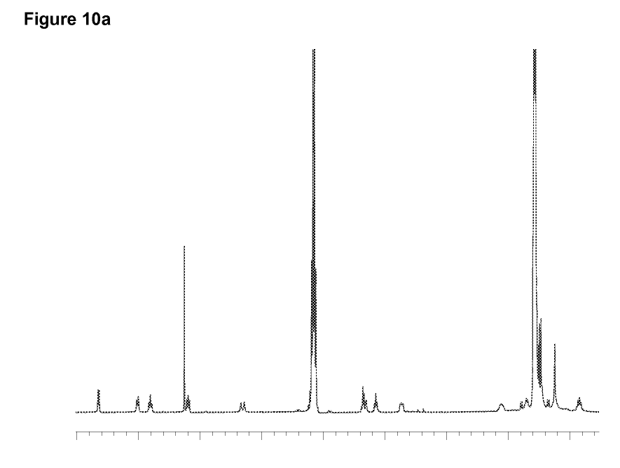

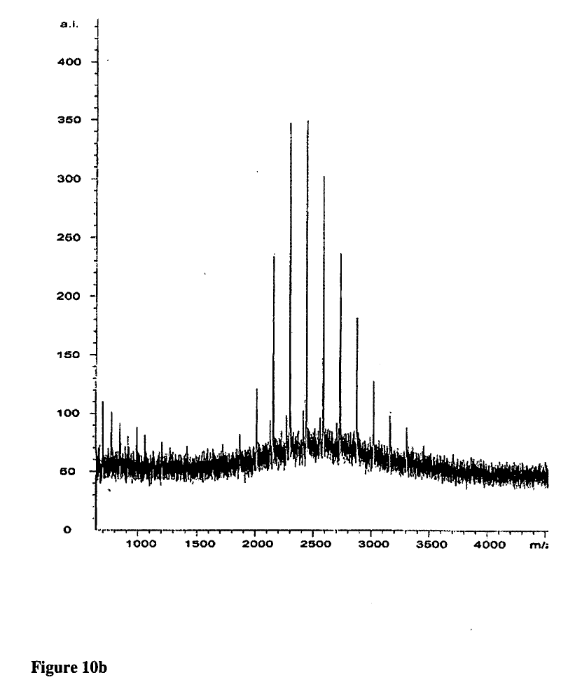

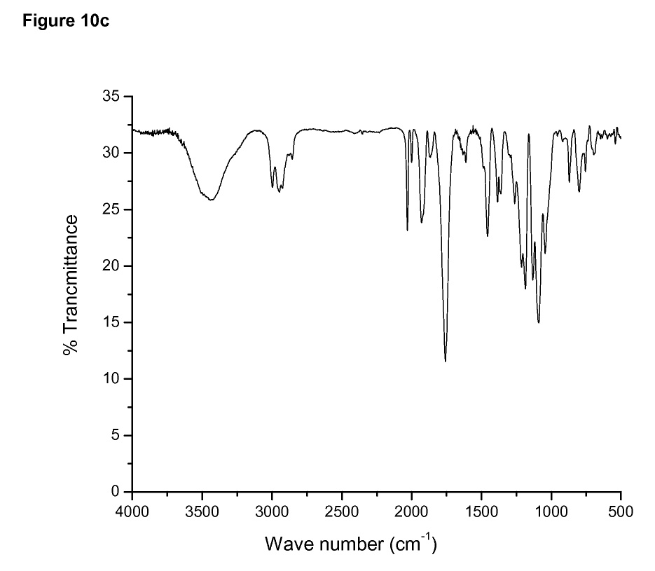

¹H NMR spectra of PLA-OC₆N₃Re(CO)₃ (formula 7) is shown in FIG. 10a, MALDI-TOF MS spectra of PLA-OC₆N₃Re(CO)₃ (formula 7) is shown in FIG. 10b, IR spectra of PLA-OC₆N₃Re(CO)₃ (formula 7) is shown in FIG. 10c.

¹H (CDCl₃, 300 MHz): δ 1.48 (d, CH₃CHOH), 1.58 (d, CH₃), 1.74-2.10 (m, CH₂, Hb,b′/c,c′/d,d′/e,e′), 3.75 (t, CH₂, Ha,a′), 4.16 (t, CH₂, Hf,f′), 4.36 (m, CH₃CHOH), 4.36 (d, CH₂, H6,6′), 5.16 (q, CH), 6.25 (d, CH₂, H6,6′), 7.20 (t, py H2,2′), 7.82 (t, py H3,3′), 8.01 (d, py H4,4′), 8.65 (d, py H1,1′). ¹³C (CDCl₃, 100 MHz): δ 196 (CO), 195.5 (CO), 175 (Cj), 169.5 (Ch), 161 (C5), 150.4 (C1), 140.3 (C4), 125.7 (C4), 125 (C2), 71.1 (Ck), 69 (Ci), 68 (Ca), 67.2 (C6), 66.6 (C6′), 65.1 (Cf), 29 (Cb), 27 (Ce), 26 (Cc), 25 (Cd), 20 (Cl), 16.5 (Cg). IR (KBr disk, cm⁻¹): 3440 (V_{OH}), 2030 (ν_{C≡O}), 1929 (ν_{C≡O}), 1758 (ν_{C═O}). MS (MALDI-TOF): m/z 2012, 2156, 2300, 2444, 2588, 2732, 2876, 3020, 3164.

PLA-OC₄N₃Re(CO)₃ (6a). PLA-OC₄N₃ (2) (52.2 mg) was dissolved in 5 ml of CH₃CN in a 3 neck round bottom flask. (NH₄)₂ReBr₃(CO)₃ (26 mg, 34.8 μmol) was dissolved in 10 ml of CH₃CN. The metal complex was added dropwise to the polymer solution under Ar with stirring. The temperature was increased to 50° C. for 3 h, the solution cooled to room temperature and the solvent removed. MeOH was added to the remaining solid. After stirring for a few minutes, the mixture was filtered and the light beige solid dried under vacuum (63 mg, 90%). ¹H (CDCl₃, 300 MHz): δ 1.42 (d, CH₃CHOH), 1.52 (d, CH₃), 1.75 (m, CH₂, Hc,c′), 2.15 (m, CH₂, Hb,b′), 3.75 (t, CH₂, Ha,a′), 4.25 (m, CH₂, Hd,d′), 4.36 (q, CH₃CHOH), 4.40 (d, CH₂, H6,6′), 5.12 (q, CH), 6.0 (d, CH₂, H6,6′), 7.05 (t, py H2,2′), 7.82 (t, py H3,3′), 7.9 (d, py H4,4′), 8.65 (d, py H1,1′). ¹³C (CDCl₃, 100 MHz): δ193.5 (CO), 192 (CO), 175.3 (Cj), 169.8 (Ch), 160 (C5), 150.2 (C1), 140.5 (C4), 125.9 (C4), 125.5 (C2), 70.8 (Ca), 70 (Ck), 69 (Ci), 67.3 (C6), 65 (Cd), 25.5 (Cb), 22.4 (Cc), 20.5 (Cl), 16.8 (Cg). IR (KBr disk, cm⁻¹): 3422 (ν_{OH}), 2031 (ν_{C≡O}), 1931 (ν_{C≡O}), 1758 (ν_{C═O}). MS (MALDI-TOF): m/z 1695, 1839, 1983, 2127, 2271, 2416, 2560, 2702.

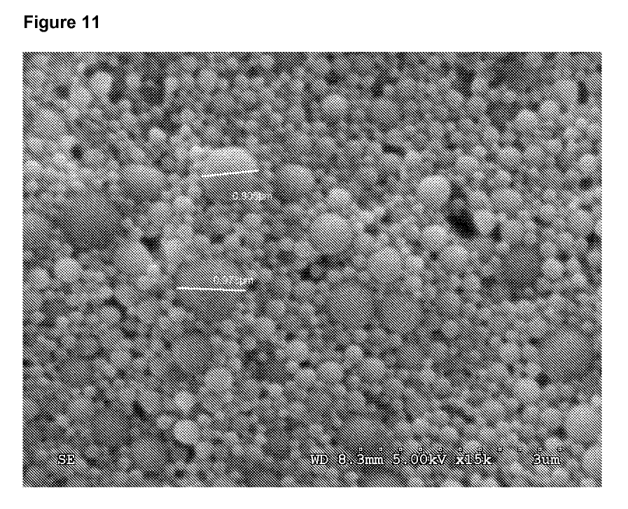

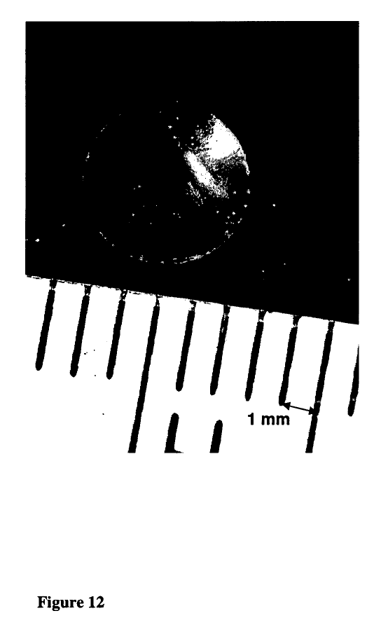

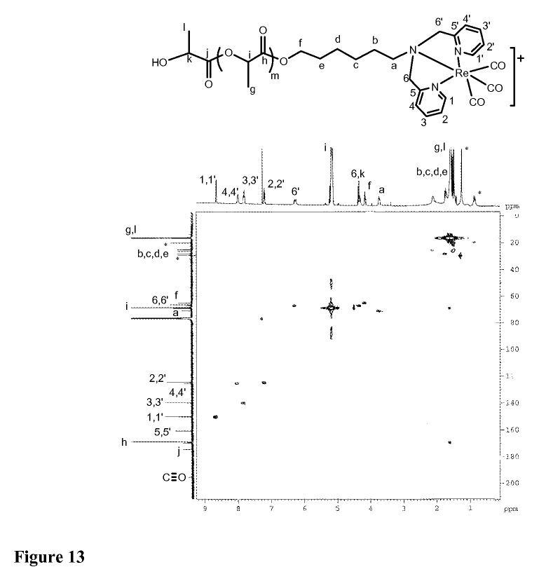

To help in the understanding and assignment of the ¹H NMR signals for formula 6a and formula 7, ¹³C NMR, ¹H-¹H COSY and ¹H-¹³C HMQC experiments were undertaken. FIG. 13 shows ¹H-¹³C HMQC spectrum of formula 7. Similar to 5 the polymer pendant has some influence on the symmetry of the ligating end group (bis(picolylamine)hexanol) after metal coordination. The CH₂ signal on the hexyl chain right next to the tertiary amine N (a) is shifted downfield for 0.75 ppm upon ligand binding. The CH₂ signal on the 0 end of the hexyl chain (f), however, does not show any significant shift or splitting unlike in 6 since the protons are farther away from the coordination site. In addition, the longer alkyl chain (hexyl vs. ethyl) has more freedom of motion and less rigidity. The pendant methylene groups on the pyridines (6,6′) show a downfield chemical shift after ligand binding. These protons again are different and exhibit diasterotopic geminal coupling (J=16 Hz) after coordination. This is due to the presence of the [Re(CO)₃]⁺ core and the effect of the polymer-ligand backbone. The pyridine protons (1-4) in this compound are shifted. There is, however, no asymmetry observed between the two rings as seen before in 5. The two signals observed in ¹³C NMR spectrum for the C≡O moiety at δ 195.5 and 196 can be explained by considering a local plane of symmetry through one carbonyl and the tertiary amine N as reported in the literature for other bis(picolylamine) coordinated fac-[Re(CO)₃]⁺ complexes. The chemical shifts for the PLA backbone and the ligand end cap are in good agreement with those reported in the literature.

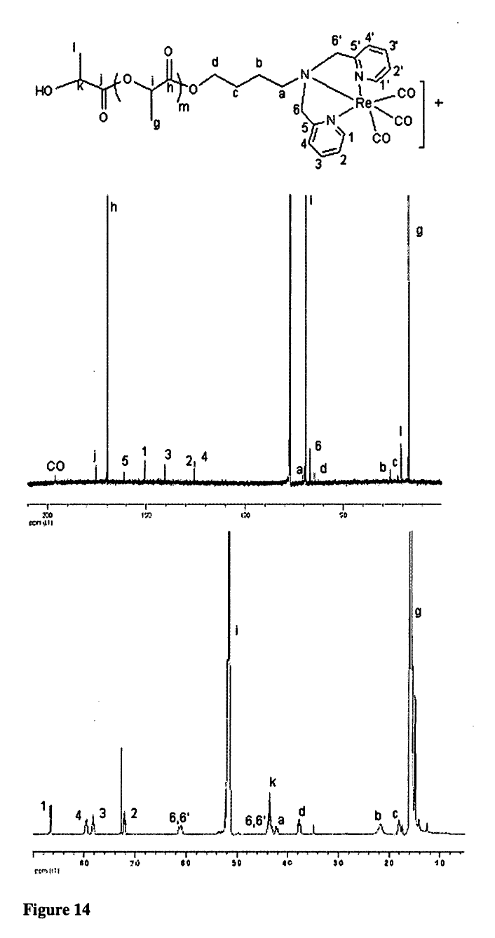

FIG. 14 shows the ¹H and ¹³C NMR spectrum of formula 6a. A similar trend is observed for this compound where the two pendant methylene groups on the pyridine rings (6,6′) are expressing geminal diastereotopic coupling (J=16 Hz). The pyridine protons are also shifted similar to the other compounds indicative of metal binding. ¹H-¹³C HMQC was used to assign ¹³C NMR of this compound. The C≡O signals are observed at δ 192 and 193.5 similar to that seen for formula 7.

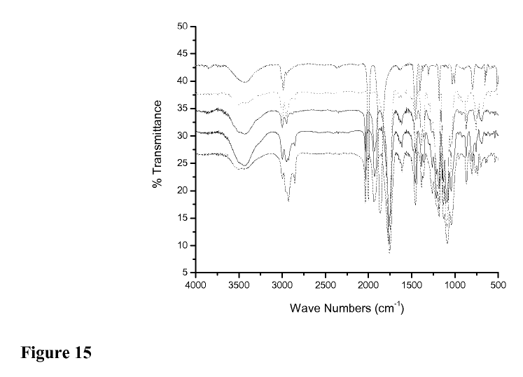

Infrared spectroscopy was also used to study these metal coordinated polymers. FIG. 15 illustrates the IR spectra of formula 6, 6a and 7 along with that of commercial L-PLA and the [Re(CO)₃]⁺ core starting material. The carbonyl section of the infrared spectra showed two bands centered near 2000 (A₁ mode) and 1900 cm⁻¹ (E mode), this is anticipated for facial tricarbonyl complexes of approximate C₃ᵥ symmetry. The lower-energy band is broadened presumably because of lower site symmetry in the polymer-ligand bound compound. The C≡O signals are observed at 1950, 2030 cm⁻¹ for 6, 1931, 2031 for 6a and at 1929, 2030 cm⁻¹ for 7 respectively and are well shifted from that of the [ReBr₃(CO)₃]⁺ precursor confirming metal chelation. Similar shifts are observed in other complexes with bis(picolylamine) coordinated [Re(CO)₃]⁺ for C≡O. In addition the aromatic signals for the bis(picolylamine) moiety is observed at about 1610 cm⁻¹.

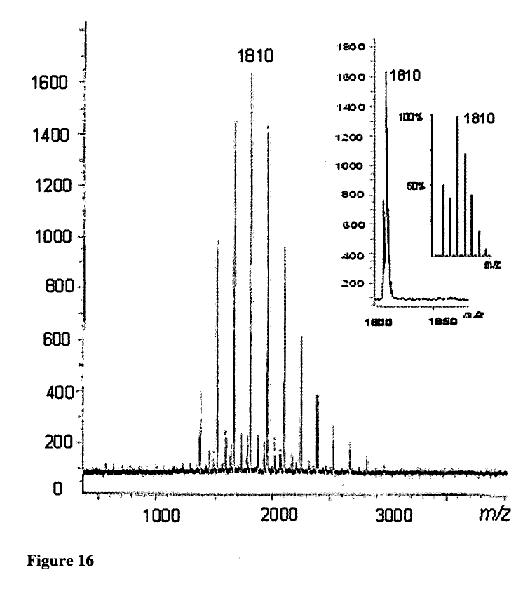

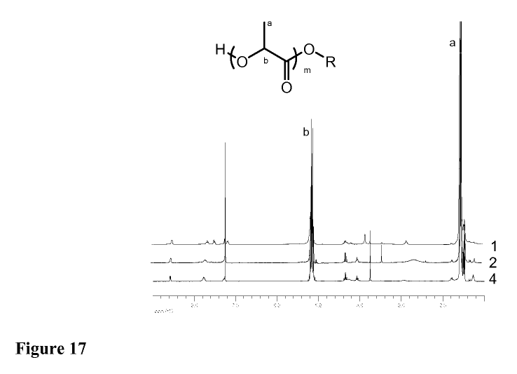

MALDI-TOF mass spectra of all metal complexes show a shift in the polymer mass relative to the added [Re(CO)₃]⁺ core. The mass can be calculated similarly based on equation 1 plus the mass of [Re(CO)₃]⁺. FIG. 16 shows the mass spectrum for 6a. It corresponds to even-numbered PLA oligomer chains of about 12-32 units with [Re(CO)₃]⁺ coordinated bis(picolylamine)ethanol and hydroxyl end caps. The insets show one actual signal and the simulation corresponding to an oligomer chain. The isotope pattern of the rhenium complex is a perfect match to the simulation mass spectrum. Calculated M_{w} and Mₙ for these polymers are presented in Table 6.

### Example 8

### Radiolabelling of Microspheres Made with 10 Weight % of the PLA-Ligand PLA-OC₆N₃ with ^{99m}Tc and Radiochemical Stability Testing

[^{99m}Tc(CO)³(H₂O)₃]⁺ was prepared from a saline solution of Na[^{99m}TcO₄] (1 ml, 740 MBq) using an “Isolink” kit (Mallinckrodt Inc). The general preparation procedure provided by Mallinckrodt was followed. Total volume was adjusted to 2 ml by addition of water.

Labelling was achieved by mixing a suspension of PLA-OC₂N₃Re(CO)₃ microspheres (˜2 mg/100 μl) in water with a 50 μl aliquot of the prepared [^{99m}Tc(CO)₃(H₂O)₃]⁺ solution and incubation at 75° C. for 30 min. TLC of the mixture with PBS as the mobile phase showed negligible release of [^{99m}Tc(CO)₃]⁺. Commercial PLA (Resomer L104, Boehringer Ingelheim) was used as control. Random release of [^{99m}Tc(CO)₃]⁺ is observed in this case. The suspension was centrifuged and a 50 μl aliquot of supernatant was taken. Activity was measured by a gamma counter. Labelling efficiency was calculated as 94.3%±0.5 for PLA-OC₂N₃Re(CO)₃ and 75.6%±1.4 for the control.

The radiochemical stability of the microspheres was then measured by incubation in 1 mM cysteine solution at 37° C. The percentage of released ^{99m}Tc was measured at 1 and 24 h (see FIGS. 11A and 11B). After 1 and 24 h, 89.3%±1.9% and 81.2%±2.2% of the radioactivity were still microsphere-bound in the case of microspheres made with PLA-OC₂N₃Re(CO)₃, while only 37.9%±2.3% and 1.9%±3.6% of the radioactivity were bound in the case of control PLA microspheres.

Microspheres were fabricated using a water-in-oil-in-water (w/o/w) double emulsion solvent evaporation technique (FIG. 11). 200 mg of PLA-OC₂N₃Re(CO)₃ was dissolved in 4 ml CH₂Cl₂. The first emulsion was prepared using a homogenizer (Polytron P T10-35; Kinematica, Lucerne, Swiss) in an ice bath at 26,000 rpm for 2.5 min. Polyvinylalcohol (PVA; 15 ml, 1%) was then added to the primary emulsion. Homogenization carried for another 2.5 min under the same conditions. This w/o/w emulsion was immediately added to 85 ml of PVA being stirred at 2000 rpm. Stirring continued for 2.5 h to evaporate the CH₂Cl₂ and at 500 rpm for another 2 h to settle the foam. Microspheres were collected by centrifugation and washed 3× with H₂O.

### Example 9

### Preparation of Polymer Films from PLA Mixed with 10 Weight % of the PLA-Ligand PLA-OC₆N₃

A mixture of PLGA 50:50 with 10% (w/w) PLA-OC₆N₃ was dissolved in CH₂Cl₂. The solvent was removed and the solid dried under vacuum for 3 h. The mixed polymer (20 mg) was placed on a Teflon sheet (1.8 cm diameter) and it was topped with another Teflon sheet of the same size. This was placed in a steel block and heated for 20 minutes at 110° C. A pressure of 41 kPa was then applied for 10 seconds to produce a smooth, clear film. Disks of 4 mm diameter were punched out of this film for radiolabelling (FIG. 12).

All citations are herein incorporated by reference.

One or more currently preferred embodiments have been described by way of example. It will be apparent to persons skilled in the art that a number of variations and modifications can be made without departing from the scope of the invention as defined in the claims.

What is claimed is:

1. A ligand-polymer comprising a chelating agent at an end of a polymer chain, wherein the chelating agent comprises a dentate structure.

2. The ligand-polymer of claim 1 wherein the dentate structure is a bidentate, tridentate, tetradentate, pentadentate, hexadentate, heptadentate, or octadentate structure.

3. The ligand-polymer of claim 1 selected from the group consisting of one or more of the structures of formula 1 to 7.

4. The ligand-polymer of claim 1 further comprising a metal atom.

5. The ligand-polymer of claim 1 wherein the metal atom is selected from the group consisting of Re, Tc, Cu, Ga, In, Y, La, Pr, Nd, Sm, Eu, Yb, Tb, Ho, Dy, Er, Tm, Lu, Ti, V, Cr, Mo, W, Mn, Tc, Fe, Ru, Co, Ni, Mo, Pd, Pt, Cu, Ag, Au, Zn, Cd, Hg, Tl, Sb, Al, Pd, Rh, Zr and Bi.

6. The ligand-polymer of claim 1 wherein the polymer is a polylactic acid, polyglycolic acid, polycaprolactone, or copolymers thereof.

7. A method of making a ligand-polymer according to any one of formula 1, 2, 3, 4, 5, 6 or 7, the method comprising heating a monomer with a ligand-initiator or a ligand-terminator in a solvent in the presence of a catalyst.

8. The method of claim 7 where the ligand-initiator or ligand-terminator is selected from the group consisting of one or more of structures 1-14.

9. A method of making a ligand-polymer comprising at least one metal atom, the method comprising combining a ligand-polymer according to any of formula 1, 2, 3, 4, 5, 6 or 7 in a solvent with a metal salt, and removing the solvent.

10. The method of claim 9 wherein the metal of the metal salt is selected from the group consisting of Re, Tc, Cu, Ga, In, Y, La, Pr, Nd, Sm, Eu, Yb, Tb, Ho, Dy, Er, Tm, Lu, Ti, V, Cr, Mo, W, Mn, Tc, Fe, Ru, Co, Ni, Pt, Cu, Ag, Au, Zn, Cd, Hg, Tl, Sb, Al, Rh, Zr, Pd and Bi.

11. The method of claim 9 wherein the metal comprises a radioactive isotope.

12. The method of claim 9 wherein the metal is Re.

13. The method of claim 11 wherein the radioactive isotope is selected from the group consisting of one or more of alpha-, beta-, gamma-, auger or positron emitters.

14. The method of claim 11 wherein the radioactive isotope comprises a radioactive atom selected from the group consisting of one or more of ^{99m}Tc, ¹⁸⁶Re, ¹⁸⁸Re, ¹¹¹In, ⁹⁰Y, ¹²³I, ¹²⁵I, ¹³¹I, ¹⁶⁶Ho, ²²⁵Ac, ⁵⁷Co, ⁶⁰Co and ⁶⁴Cu.
